(19) United States
(12) Patent Application Publication
(10) Pub. No.: US 2026/0360995 A1
(43) Pub. Date: Nov. 12, 2026

(54) CAVITY-BACKED MICROSTRIP DIPOLE ANTENNA

(71) Applicant: LG ELECTRONICS INC., Seoul (KR)

(72) Inventors: Youngtaek HONG, Seoul (KR); Ilnam CHO, Seoul (KR); Byungwoon JUNG, Seoul (KR); Woocheol CHOI, Seoul (KR)

(73) Assignee: LG ELECTRONICS INC., Seoul (KR)

(21) Appl. No.: 19/121,687

(22) PCT Filed: Oct. 28, 2022
(86) PCT No.: PCT/KR2022/016755

§ 371 Date: Apr. 16, 2025

(51) Int. Cl. H01Q 21/06; H01Q 21/00

(52) U.S. Cl. CPC H01Q 21/062; H01Q 21/0075

(57) ABSTRACT

This cavity-backed microstrip dipole antenna array may comprise a printed circuit board (PCB) and a metal substrate. The PCB may comprise: a dielectric substrate; a ground disposed on a second surface of the dielectric substrate, the ground including a first open area, a second open area, and a third open area; radiators disposed in the first open area on the second surface of the dielectric substrate, a first end of each of the radiators being connected to a part of the ground; a microstrip feeder disposed on a first surface of the dielectric substrate, a part of the ground being electrically coupled to the microstrip feeder; and a conductive pattern disposed on the second surface of the dielectric substrate, the conductive pattern being electrically coupled to a second end of each of the radiators.

### TECHNICAL FIELD

The present disclosure relates a cavity-backed microstrip antenna. A particular implementation relates to a cavity-backed microstrip antenna array and an electronic device including the same.

### BACKGROUND ART

As functions of electronic devices diversify, the electronic devices may be implemented as image display devices such as multimedia players having complex functions, for example, playing music or video files, playing games, receiving broadcasts, and the like.

An image display device is a device for reproducing (playing) image contents. Image display devices receive images (videos) from various sources and reproduce the received images. Image display devices are implemented as various devices such as personal computers (PC), smart phones, tablet PCs, laptop computers, TV sets, and the like. An image display device, such as a smart TV, may provide an application for providing web contents, such as web browsers.

Communication module design technologies for supporting ultra-high speed and large capacity communications are rapidly evolving together with rapid development of 5th/6th generation (5G/6G) mobile communication. Accordingly, the demand for the development of transmitters and receivers in millimeter wave and terahertz bands is increasing significantly.

In some embodiments, in addition to WiFi wireless interfaces, ultra-high-speed wireless interfaces using a terahertz (THz) band may be considered as interfaces for communication services between electronic devices. When using the ultra-high-speed wireless interface, a terahertz band as well as a millimeter wave (mmWave) band may be used for high-speed data transmission between the electronic devices.

A terahertz (THz) band refers to a frequency band between 100 GHz and 10 THz, and generally, as the frequency band increases, a wider communication bandwidth may be used, making it suitable for the ultra-high-speed communications required for 6G. The terahertz band is considered as a candidate frequency band of 6G communication, which aims to achieve a data transmission speed of 1 Tbps (speed of transmitting one trillion bits per second), which is up to 50 times faster than the data transmission speed (up to 20 Gbps) of 5G communication. However, as the frequency band gets higher, great path loss is caused, resulting in shorter radio wave propagation distances due to the characteristics of radio waves. Therefore, an advanced beamforming technology is required to integrate numerous antennas inside a communication system and transmit and receive radio waves in a specific direction.

Recently, research on 6G THz band transceivers is mainly being conducted in a D-band (110 GHz to 170 GHz) frequency band. Accordingly, a broadband antenna with a very wide operating band within the D-band needs to be designed. Additionally, in 6G communications, a free space path loss according to a distance between a transmitter and a receiver is great. Therefore, a high gain antenna for compensating for a high signal loss needs to be designed.

When a 6G antenna is designed, a patch antenna with high directivity may be used to increase a radiation gain of the antenna. However, the patch antenna has a narrow operating frequency band and a limited antenna gain. Therefore, a cavity antenna that performs broadband operation and has a high gain in a 120 GHz band needs to be designed. In this regard, additional improvements in an operating bandwidth and radiation gains are needed to meet performance requirements in actual 6G communications.

### DISCLOSURE OF INVENTION

### Technical Problem

Therefore, to obviate those problems, the detailed description is to provide an antenna module operating in a terahertz band for 6G communication and an electronic device including the same.

An objective of the specification is to design an antenna structure for a terahertz band with a high radiation gain and wide bandwidth performance.

An objective of the specification is to secure high radiation gain performance in a whole 6G frequency band.

An objective of the specification is to improve antenna directivity and a radiation gain by in-phase synthesizing electric field distributions between antenna structures.

### Solution to Problem

To achieve these and other advantages and in accordance with the purpose of the present disclosure, as embodied and broadly described herein, a cavity-backed microstrip dipole antenna array according to an embodiment may include a printed circuit board (PCB) and a metal substrate. The PCB may include: a dielectric substrate; a ground arranged on a second surface of the dielectric substrate, the ground including a first open area, a second open area, and a third open area; radiators arranged in the first open area on the second surface of the dielectric substrate, a first end of each of the radiators being connected to a part of the ground; a microstrip feeder arranged on a first surface of the dielectric substrate, a part of the ground being electrically coupled to the microstrip feeder; and a conductive pattern arranged on the second surface of the dielectric substrate, the conductive pattern being electrically coupled to a second end of each of the radiators.

As an embodiment, the metal substrate may include: a third surface; a fourth surface being at an opposite side to the third surface, wherein the fourth surface of the metal substrate is faced with the first surface of the dielectric substrate; a first cavity arranged on the fourth surface of the metal substrate, the first cavity being arranged at a position overlapping the radiators and a first part of the conductive pattern; a second cavity arranged on the fourth surface of the metal substrate, the second cavity being arranged at a position overlapping a second part of the conductive pattern; and a third cavity arranged on the fourth surface of the metal substrate, the third cavity being connected to the first cavity and the second cavity, and the third cavity being arranged at a position overlapping a middle part between the first part and the second part of the conductive pattern.

As an embodiment, a size, a shape, and a depth of the first cavity may be identical to a size, a shape, and a depth of the second cavity, and a size and a depth of the third cavity may be smaller than the size and the depth of the second cavity.

As an embodiment, the PCB may include: a dielectric substrate; a ground arranged on a second surface of the dielectric substrate, the ground including a first open area, a second open area, and a third open area; radiators arranged in the first open area on the second surface of the dielectric substrate, a first end of each of the radiators being connected to a part of the ground; a microstrip feeder arranged on a first surface of the dielectric substrate, a part of the ground being electrically coupled to the microstrip feeder; and a conductive pattern arranged on the second surface of the dielectric substrate, the conductive pattern being electrically coupled to a second end of each of the radiators.

As an embodiment, an inner side of the first cavity, an inner side of the second cavity, and an inner side of the third cavity may be composed of air.

As an embodiment, the ground may constitute an open area, and radiators may be arranged in the open area.

As an embodiment, the open area of the ground may have a size smaller than the size of the first cavity.

As an embodiment, the radiators may be configured as a first radiator pattern and a second radiator pattern. A first part of a slot may be arranged between the first radiator pattern and the second radiator pattern. A second part of the slot may be arranged on the ground connected to the radiators. The first part of the slot and the second part of the slot are connected to each other. A gap in the second part of the slot is configured to be wider than the first part of the slot.

As an embodiment, the sizes of the first cavity and the second cavity may be each 1.18×0.74 mm in horizontal and vertical directions, and the depths of the first cavity and the second cavity may be each 0.35 mm.

As an embodiment, the depth of the third cavity may be 0.13 mm.

As an embodiment, the first cavity and the second cavity may be each arranged as three pieces at a central region and at one side region and another side region adjacent to the central region in a horizontal direction. The third cavity is configured to connect the first cavity and the second cavity each in the central region in which the radiator is arranged. The size of the third cavity may be 0.12×0.5 mm in horizontal and vertical directions.

As an embodiment, a height of the metal substrate may be 1.0 mm.

As an embodiment, a height of the dielectric substrate may be 80 um.

A cavity-backed microstrip dipole antenna array according to an embodiment of the specification may include a printed circuit board (PCB) including: a dielectric substrate; a ground arranged on a first surface of the dielectric substrate, the ground including a first open area, a second open area, and a third open area; a first radiator arranged in the first open area on the first surface of the dielectric substrate, a first end of the first radiator being connected to a first part of the ground; a second radiator arranged in the first open area on the first surface of the dielectric substrate, a third end of the second radiator being connected to a second part of the ground; a first gap arranged between the first part of the ground and the second part of the ground; a second gap arranged between the first radiator and the second radiator; a microstrip feeder arranged on a second surface of the dielectric substrate, the microstrip feeder being electrically coupled to the first part and the second part of the ground; and a conductive pattern arranged on the first surface of the dielectric substrate, the conductive pattern being electrically coupled to a second end of the first radiator and a fourth end of the second radiator.

As an embodiment, the antenna array may include a metal substrate, wherein the metal substrate may include: a third surface; a fourth surface being at an opposite side to the third surface, wherein the fourth surface of the metal substrate is faced with the first surface of the dielectric substrate; a first cavity arranged on the fourth surface of the metal substrate, the first cavity being arranged at a position overlapping the first radiator and the second radiator and a first part of the conductive pattern; a second cavity arranged on the fourth surface of the metal substrate, the second cavity being arranged at a position overlapping a second part of the conductive pattern; and a third cavity arranged on the fourth surface of the metal substrate, the third cavity being connected to the first cavity and the second cavity, and the third cavity being arranged at a position overlapping a middle part between the first part and the second part of the conductive pattern, and a size, a shape and a depth of the first cavity may be identical to a size, a shape and a depth of the second cavity, and a size and a depth of the third cavity may be smaller than the size and the depth of the second cavity

As an embodiment, an inner side of the first cavity, an inner side of the second cavity, and an inner side of the third cavity may be composed of air.

As an embodiment, the ground may constitute an open area, and the first and second radiators may be arranged in the open area.

As an embodiment, the open area of the ground may have a size smaller than the size of the first cavity.

As an embodiment, a first part of a slot may be arranged between the first radiator and the second radiator. A second part of the slot may be arranged on the ground connected to the radiators. The first part of the slot and the second part of the slot may be connected to each other. A gap in the second part of the slot may be configured to be wider than the first part of the slot.

As an embodiment, the sizes of the first cavity and the second cavity may be each 1.18×0.74 mm in horizontal and vertical directions, and the depths of the first cavity and the second cavity may be each 0.35 mm.

As an embodiment, the depth of the third cavity may be 0.13 mm.

As an embodiment, the first cavity and the second cavity may be each arranged as three pieces at a central region and at one side region and another side region adjacent to the central region in a horizontal direction, the third cavity may be configured to connect the first cavity and the second cavity each in the central region in which the radiators are arranged, and the size of the third cavity may be configured as 0.12×0.5 mm in horizontal and vertical directions.

As an embodiment, a height of the metal substrate may be 1.0 mm.

As an embodiment, a height of the dielectric substrate may be 80 um.

### Advantageous Effects of Invention

Hereinafter, technical effects of a cavity-backed microstrip antenna array and an electronic device including the same are described.

According to an embodiment, an antenna module operating in a terahertz band and an electronic device including the same may be provided.

According to an embodiment, an antenna structure for a terahertz band having a high radiation gain and wide bandwidth performance through a multi-cavity structure may be designed.

According to an embodiment, high radiation gain performance may be secured in a whole 6G frequency band through optimal design of a shape, a size, and a depth of a multi-cavity structure.

According to an embodiment, electric field distributions between antenna structures may be synthesized in phase through optimal design of a shape, a size, and a depth of a multi-cavity structure, thereby improving antenna directivity and a radiation gain.

Further scope of applicability of the disclosure will become apparent from the following detailed description. It should be understood, however, that the detailed description and specific examples, such as the preferred embodiments, are given by way of illustration only, because various changes and modifications within the technical idea and scope of the disclosure will be apparent to those skilled in the art.

### BRIEF DESCRIPTION OF DRAWINGS

FIG. 1 is a view of an example of an electromagnetic spectrum including millimeter wave and terahertz bands according to the specification.

FIG. 2 is a view of an example of a THz communication application according to the specification.

FIG. 3 is a view of examples of a communication system applied to the specification and devices performing wireless communications through the communication system.

FIG. 4 is a view of a configuration of wireless devices performing wireless communications according to the specification.

FIG. 5 is a view of an electronic device in which a plurality of antenna modules and a plurality of transceiver circuit modules according to an embodiment are arranged.

FIG. 6A is a view of a configuration, in which a multi-layer circuit board having an array antenna module arranged therein is connected to an RFIC, in relation to THz band communication according to the specification.

FIG. 6B is a view of a coupling structure between a multi-layer substrate and a main substrate according to embodiments.

FIGS. 7A to 7C illustrate a microstrip dipole antenna having a single cavity-backed structure.

FIGS. 8A and 8B show reflection coefficients and gain characteristics of a microstrip dipole antenna having a single cavity-backed structure.

FIGS. 9A to 9C illustrate a microstrip dipole antenna having a plurality of cavities according to the specification arranged therein.

FIGS. 10A and 10B illustrate an exploded perspective view and a front view of an antenna structure in which a plurality of cavities are arranged in a dielectric substrate according to an embodiment of the specification, respectively.

FIG. 11A shows comparison between reflection coefficients and radiation gains of an antenna having a single cavity structure and an antenna having a multi-cavity structure, respectively.

FIGS. 11B and 11C show electric field distributions in an antenna having the single cavity structure and an antenna having the multi-cavity structure in first and second side directions, respectively.

FIGS. 12A and 12B show simulation results of reflection coefficient characteristics and radiation gain characteristics of an antenna in a structure in which a plurality of cavities of FIG. 10B are configured to have a same length.

FIG. 13A shows antenna radiation gain characteristics according to a width of a second cavity.

FIG. 13B shows electric field distribution of an antenna structure having second cavities with different width values.

FIG. 13C shows a three-dimensional (3D) radiation pattern of the antenna structure having the second cavities with different width values of FIG. 13B.

FIG. 14A shows antenna radiation gain characteristics according to a change in a gap between first and second cavities.

FIG. 14B shows electric field distribution of an antenna structure having first and second cavities with different gap values.

FIG. 14C shows a 3D radiation pattern of the antenna structure having the first and second cavities with the different gap values of FIG. 14B.

FIG. 15A shows antenna radiation gain characteristics according to a change in a length of a second sub-pattern.

FIG. 15B shows electric field distributions of antenna structures including second sub-patterns having different lengths, respectively.

FIG. 15C shows a 3D radiation pattern of the antenna structure having the second sub-patterns having different lengths and shown in FIG. 15B.

FIGS. 16A and 16B illustrate a cavity-backed microstrip dipole antenna array structure.

FIG. 17A is a view of a structure in which an antenna module having a first type antenna and a second type antenna configured as array antennas is arranged on an electronic device.

FIG. 17B is an enlarged view of a plurality of array antenna modules.

FIG. 18 is a view of an antenna module coupled in a different coupling structure at a specific position of an electronic device according to embodiments.

### MODE FOR THE INVENTION

A description will now be given in detail according to one or more embodiments disclosed herein, with reference to the accompanying drawings. For the sake of a brief description with reference to the drawings, the same or equivalent components may be provided with the same reference number, and the description thereof will not be repeated. Suffixes “module” and “unit” used for components used in the following description are merely intended for easy description of the specification, and each suffix itself is not intended to give any special meaning or function. In describing the embodiments disclosed herein, moreover, the detailed description will be omitted when a specific description for publicly known technologies to which the disclosure pertains is judged to obscure the gist of the disclosure. The accompanying drawings are used to help easily understand the technical idea of the disclosure and it should be understood that the idea of the disclosure is not limited by the accompanying drawings. The idea of the present disclosure should be construed to extend to any alterations, equivalents, and substitutes besides the accompanying drawings.

It will be understood that although the terms first, second, and the like may be used herein to describe various elements, these elements should not be limited by these terms. These terms are generally only used to distinguish one element from another.

It will be understood that when an element is referred to as being “connected with” another element, the element may be connected with the another element or intervening elements may also be present. In contrast, when an element is referred to as being “directly connected with” another element, there are no intervening elements present.

The singular forms are intended to include the plural forms as well, unless the context clearly indicates otherwise.

The term “include” or “has” as used herein should be understood that it is intended to indicate the existence of a feature, a number, a step, an element, a component, or a combination thereof disclosed in the specification, and it may also be understood that the existence or additional possibility of one or more other features, numbers, steps, elements, components, or combinations thereof are not excluded in advance.

The following technology may be used in various wireless access systems, such as CDMA, FDMA, TDMA, OFDMA, SC-FDMA, and the like. The CDMA may be implemented as wireless technology, such as universal terrestrial radio access (UTRA) or CDMA2000. The TDMA may be implemented as wireless technology, such as global system for mobile communications (GSM)/general packet radio service (GPRS)/enhanced data rates for GSM evolution (EDGE). The OFDMA may be implemented as wireless technology, such as institute of electrical and electronics engineers (IEEE) 802.11 (Wi-Fi), IEEE 802.16 (WiMAX), IEEE 802-20, evolved UTRA (E-UTRA), or the like. The UTRA is part of the universal mobile telecommunications system (UMTS). Third generation partnership project (3GPP) long term evolution (LTE) is a part of evolved UMTS (E-UMTS) that uses E-UTRA, and LTE-advanced (LTE-A)/LTE-A pro is an evolved version of 3GPP LTE. 3GPP new radio or new radio (NR) access technology is an evolved version of 3GPP LTE/LTE-A/LTE-A pro. 3GPP 6G may be an evolved version of 3GPP NR.

### Overall 6G System

6G (wireless communication) systems are aimed at (i) very high data rates per device, (ii) a very large number of connected devices, (iii) global connectivity, (iv) very low latency, (v) reduced energy consumption for battery-free IoT devices, (vi) ultra-reliable connectivity, and (vii) connected intelligence with machine learning capabilities. The vision of 6G system may be divided into four aspects: intelligent connectivity, deep connectivity, holographic connectivity, and ubiquitous connectivity, and the 6G system may satisfy the requirements as shown in Table 1 below. That is, Table 1 shows an example of the requirements of the 6G system.

TABLE 1

| | |
|---|---|
| Per device peak data rate | 1 Tbps |
| E2E latency | 1 ms |
| Maximum spectral efficiency | 100 bps/Hz |
| Mobility support | Up to 1000 km/h |
| Satellite integration | Fully |
| AI | Fully |
| Autonomous vehicle | Fully |
| XR | Fully |
| Haptic Communication | Fully |

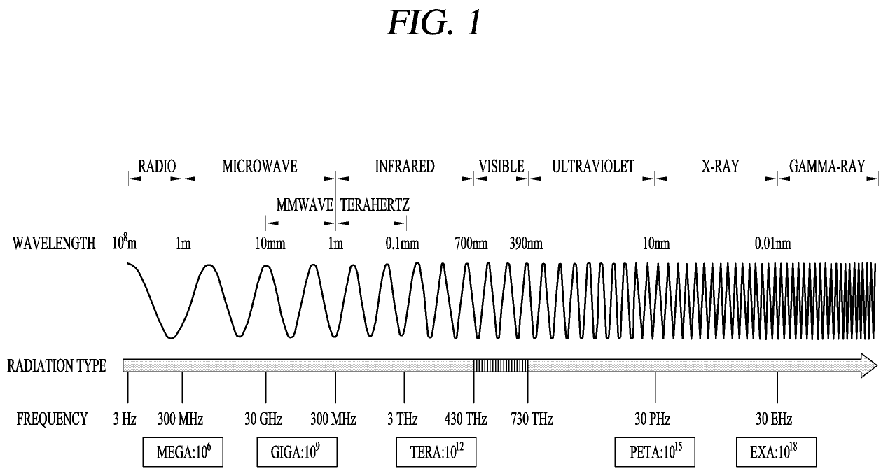

6G systems may have key factors, such as enhanced mobile broadband (eMBB), ultra-reliable low latency communications (URLLC), massive machine-type communication (mMTC), AI integrated communication, tactile Internet, high throughput, high network capacity, high energy efficiency, low backhaul and access network congestion, and enhanced data security. FIG. 1 is a view of an example of a communication structure that may be provided in a 6G system.

It is anticipated that the 6G system has simultaneous wireless communication connectivity which is 50 times higher than the 5G wireless communication system. URLLC which is the key feature of 5G will be even more important technology by providing a smaller end-to-end latency than 1 ms in the 6G communication. In the 6G system, volume spectrum efficiency will be even more excellent unlike area spectrum efficiency frequently used.

### Terahertz (THz) Communication

The data rate may be increased by increasing a bandwidth. This may be performed by using sub-THz communication with a wide bandwidth, and applying an advanced massive MIMO technology. A THz wave, also known as a radiation of millimeters or less generally shows a frequency band between 0.1 THz and 10 THz having a corresponding wavelength ranging from 0.03 mm to 3 mm. A band range of 100 GHz to 300 GHz (sub-THz band) is regarded as a primary part of the THz band for cellular communication. A 6G cellular communication capacity increases when the sub-THz band is added to a mmWave band. A band range of 300 GHz to 3 THz in a defined THz band is present in an infrared (IR) frequency band. The band range of 300G Hz to 3 THz is a part of a wideband, but is present on a boundary of the wideband, and is present just behind an RF band. Therefore, the band range of 300G Hz to 3 THz shows a similarity to the RF.

In this regard, FIG. 1 is a view of an example of an electromagnetic spectrum including millimeter wave and terahertz bands according to the specification.

Referring to FIG. 1, a THz wave may be located between a radio frequency (RF)/millimeter wave (mm) and an IR band, and (i) may have high straightness and enable beam convergence by virtue of better transmission of a non-metallic/non-polarizable material than visible light/infrared rays, and a shorter wavelength than the RF/millimeter wave. Further, photon energy of the THz wave is harmless to a human body because the photon energy is only several meV. A frequency band which is expected to be used for THz wireless communication may be a D-band (110 GHz to 170 GHz) or an H-band (220 GHz to 325 GHz) having less wave loss by molecular absorption in the air. The standardization of the THz wireless communication is discussed by the IEEE 802.15 THz working group, along with 3GPP, and a standard document issued by the IEEE 802.15 Task Group (TG3d, TG3e) may embody or supplement the contents described in this specification.

The THz wireless communication may be applied in wireless cognition, sensing, imaging, wireless communication, THz navigation, and the like. Main features of the THz communication may include (i) a bandwidth widely usable to support a very high data rate, and (ii) a high path loss occurred at a high frequency (a high directional antenna is essential). A narrow beam width generated by the high directional antenna reduces interference. A small wavelength of a THz signal may allow even more antenna elements to be integrated into a device and a BS which operate in this band. Through this, an advanced adaptive arrangement technology capable of overcoming range limitations may be used.

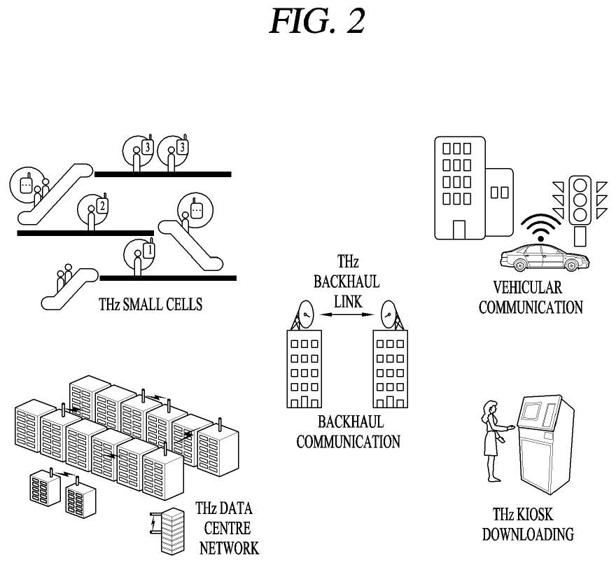

FIG. 2 is a view of an example of a THz communication application according to the specification. As illustrated in FIG. 2, a THz wireless communication scenario may be categorized into a macro network, a micro network, and a nanoscale network. In the macro network, the THz wireless communication may be applied to a vehicle-to-vehicle connection and a backhaul/fronthaul connection. In the micro network, the THz wireless communication may be applied to an indoor small cell, a fixed point-to-point or multi-point connection, such as wireless connection in a data center, and near-field communication, such as kiosk downloading.

Table 2 below is a table that shows an example a technology which may be used in the THz wave.

TABLE 2

| | |
|---|---|
| Transceivers Device | Available immature, UTC-PD, RTD, |
| | and SBD |
| Modulation and Coding | Low order modulation techniques |
| | (OOK, QPSK), LDPC, Reed Soloman, |
| | Hamming, Polar, Turbo |
| Antenna | Omni and Directional, Phased array |
| | with low number of antenna elements |
| Bandwidth | 69 GHz (or 23 GHz) at 300 GHz |
| Channel models | Partially |
| Data rate | 100 Gbps |
| Outdoor deployment | No |
| Free space loss | High |
| Coverage | Low |
| Radio Measurements | 300 GHz indoor |
| Device size | Few micrometers |

### Optical Wireless Technology

An OWC technology has been planned for 6G communication in addition to RF-based communication for all available device-to-access networks. The network is connected to a network-to-backhaul/fronthaul network connection. The OWC technology is already used after a 4G communication system, but may be more widely used for meeting the requirements of a 6G communication system. The OWC technologies, such as light fidelity, visible light communication, optical camera communication, and FSO communication based on a wideband are already well known. The optical wireless technology-based communication may provide very high data speed, low latency time, and safe communication. LiDAR may also be used for super-ultra high resolution 3D mapping in the 6G communication based on the wideband.

### FSO Backhaul Network

Transmitter and receiver features of an FSO system are similar to the features of an optical fiber network. Therefore, data transmission of the FSO system is similar to that of the optical fiber system. Therefore, the FSO may be an excellent technology that provides a backhaul connection in the 6G system together with the optical fiber network. When the FSO is used, very long-distance communication is enabled even at a distance of 10000 km or more. The FSO supports a massive backhaul connection for remote and non-remote regions such as the sea, the space, the underwater, and an isolated island. The FSO also supports a cellular BS connection.

### Massive MIMO Technology

One of core technologies for enhancing spectrum efficiency is to apply a MIMO technology. When the MIMO technology is enhanced, the spectrum efficiency is also enhanced. Therefore, the massive MIMO technology may be important in the 6G system. The MIMO technology uses a plurality of paths, and thus a multiplexing technology and a beam generation and operating technology suitable for the THz band should also be considered importantly so that a data signal is transmitted through one or more paths.

### Blockchain

The blockchain will become an important technology for managing massive data in a future communication system. The blockchain is a form of a distributed ledger technology, and the distributed ledger is a database distributed in numerous nodes or computing devices. Each node replicates and stores the same ledger copy. The blockchain is managed by a P2P network. The blockchain may be present without being managed by a centralized agency or server. Data of the blockchain is jointly collected and constituted by blocks. The blocks are connected to each other, and protected by using encryption. The blockchain fundamentally perfectly complements massive IoT through enhanced interoperability, security, personal information protection, stability, and scalability. Therefore, the blockchain technology provides various functions, such as inter-device interoperability, massive data traceability, autonomous interactions of different IoT systems, and massive connection stability of the 6G communication system.

### 3D Networking

The 6G system supports user communication of vertical scalability by integrating ground and aerial networks. A 3D BS may be provided through a low-orbit satellite and a UAV. A 3D connection is quite different from the existing 2D network when a new dimension is added in terms of an altitude and a related degree of freedom.

### Quantum Communication

In the context of the 6G network, unsupervised reinforcement learning of the network is promising. The supervised learning scheme is not allowed to designate a label in a vast amount of data generated in the 6G. The labeling is not required in the unsupervised learning. Therefore, the technology may be used for autonomously constructing a complicated network expression. The network may be operated by a true autonomous scheme when the reinforcement learning and the unsupervised learning are combined.

### Unmanned Aerial Vehicle

The unmanned aerial vehicle (UAV) or a drone will become an important element in the 6G wireless communication. In most cases, a high-speed data wireless connection is provided by using a UAV technology. A BS entity is installed in the UAV to provide cellular connection. The UAV has a specific function which may not be seen in a fixed BS infrastructure, such as easy deployment, strong visible-line link, the degree of freedom in which mobility is controlled. During emergencies, such as natural disasters, the arrangement of a ground communication infrastructure is not enabled to be economically realized, and sometimes services may not be provided in volatile environments. The UAV may easily handle these situations. The UAV will become a new paradigm of a wireless communication field. This technology facilitates three basic requirements of the wireless network, i.e., eMBB, URLLC, and mMTC. The UAV may also support various purposes, such as network connectivity enhancement, fire sensing, disaster emergency services, securing and monitoring, pollution monitoring, parking monitoring, accident monitoring, and the like. Therefore, the UAV technology is recognized as one of the most important technologies for the 6G communication.

### Cell-Free Communication

The close integration of multiple frequencies and heterogeneous communication technologies is very important in the 6G system. As a result, a user may move smoothly from a network to another network without the need to create any manual configuration in a device. A best network is automatically selected in an available communication technology. This will break the limitation of a cell concept in wireless communication. Currently, user movement from one cell to another cell causes too many handovers in the network, and causes handover failures, handover latency, data loss, and pingpong effects. 6G cell-free communication will overcome all of the problems, and provide better QoS. The cell-free communication will be achieved through different heterogeneous radios of multi-connectivity and multi-tier hybrid technologies and devices.

### Wireless Information and Energy Transmission Integration

WIET uses the same field and wave as the wireless communication system. In particular, the sensor and the smartphone may be charged by using wireless power transmission during communication. The WIET is a promising technology for extending the lifespan of a battery charging wireless system. Therefore, a device without a battery may be supported in the 6G communication.

### Integration of Sensing and Communication

An autonomous wireless network is a function to continuously sense an environmental state which dynamically changes, and exchange information between different nodes. In the 6G, the sensing may be closely integrated with communication to support an autonomous system.

### Integration of Access Backhaul Networks

In the 6G, the density of the access network may be enormous. Each access network is connected by the backhaul network, such as the optical fiber and the FSO network. To cope with a very larger number of access networks, there may be a close integration between the access and the backhaul network.

### Hologram and Beamforming

The beamforming is a signal processing procedure of adjusting an antenna array to transmit a radio signal. The beamforming is a sub-set of a smart antenna or advanced antenna system. The beamforming technology has several advantages, such as a high call-to-noise ratio, interference prevention and denial, and high network efficiency. The hologram and beamforming (HBF) is a new beamforming method which is significantly different from the MIMO system because a software-defined antenna is used. The HBF may be a very effective approach scheme for efficient and flexible transmission and reception of signals in a multi-antenna communication device for 6G communication.

### Big Data Analysis

The big data analysis is a complicated process for analyzing various large-scale data sets or big data. This process guarantees perfect data management by finding hidden data, and information such as a correlation and a customer tendency which may not be known. The big data is collected from various sources such as videos, social networks, images, and sensors. This technology is widely used to process vast data in the 6G system.

### Large Intelligent Surface (LIS)

A THz band signal has a strong straightness, so there may be a lot of shade regions due to obstacles, and an LIS technology becomes important in which the LIS is installed near such a shade region to expand a communication zone and to enable communication stability strengthening and additional services. The LIS is an artificial surface made of electromagnetic materials, and may change propagations of incoming radio waves and outgoing radio waves. The LIS may be shown as an extension of massive MIMO, but is different from the massive MIMO in terms of an array structure and an operating mechanism. Further, the LIS has an advantage of maintaining low power consumption in that the LIS operates as a reconfigurable reflector having passive elements, i.e., reflects signals only passively without using an active RF chain. Further, the reflector may be advantageous for the wireless communication channel because each passive reflector of the LIS should independently control a phase shift of an incident signal. By appropriately controlling the phase shift through an LIS controller, a reflected signal may be gathered in a target receiver to boost a received signal power.

The 6G communication technology described above may be applied in combination with methods proposed in the disclosure to be described below or may be supplemented to specify or clarify technical features of the methods proposed in the disclosure. In some embodiments, the communication service proposed in the disclosure may be applied in combination with communication services by 3G, 4G, and/or 5G communication technology, along with the 6G communication technology described above.

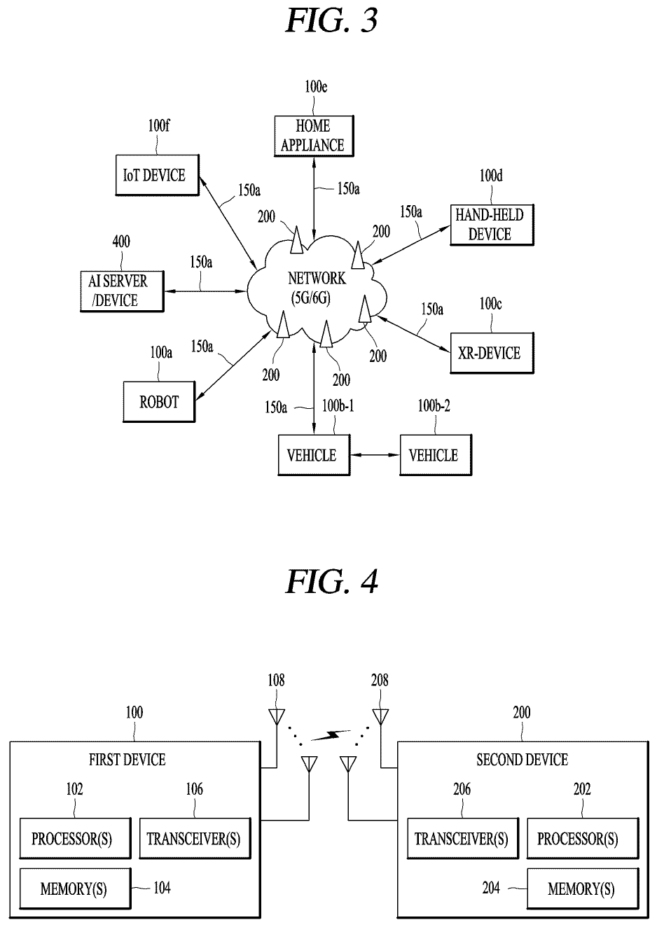

FIG. 3 is a view of examples of a communication system applied to the specification and devices performing wireless communications through the communication system. Referring to FIG. 3, a communication system 1 applied to the disclosure includes wireless devices, base stations, and a network. Herein, the wireless devices represent devices performing communications using radio access technology (RAT) (e.g., 5G new RAT (NR)) or long-term evolution (LTE)) and may be referred to as communication/radio/5G devices. The wireless devices may include, without being limited to, a robot 100a, vehicles 100b-1 and 100b-2, an eXtended reality (XR) device 100c, a hand-held device 100d, a home appliance 100e, an Internet of thing (IoT) device 100f, and an artificial intelligence (AI) device/server 400. For example, the vehicles may include a vehicle having a wireless communication function, an autonomous driving vehicle, and a vehicle capable of performing vehicle-to-vehicle communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, and the like. The hand-held device may include a smartphone, a smart pad, a wearable device (e.g., a smartwatch or smart glasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., vehicle-to-vehicle (V2V)/vehicle-to-everything (V2×) communication). The IoT device (e.g., a sensor) may perform direct communication with other IoT devices (e.g., sensors) or other wireless devices 100a to 100f.

Wireless communications/connections 150a and 150b may be performed between the wireless devices 100a to 100f/BSs 200 and the BSs 200/wireless devices 100a to 100f. Here, wireless communications/connections may be performed through various radio access technologies (e.g., 5G NR) for uplink/downlink communication 150a and sidelink communication 150b (or D2D communication). Through the wireless communications/connections 150a and 150b, the wireless devices and the BSs/wireless devices may transmit/receive radio signals to each other. For example, the wireless communications/connections 150a and 150b may transmit/receive signals through various physical channels based on all/partial processes of FIG. A1. To this end, based on various proposals of the disclosure, at least some of various configuration information setting processes for transmitting/receiving radio signals, various signal processing processes (e.g., channel encoding/decoding, modulation/demodulation, resource mapping/demapping, and the like), or a resource allocation process may be performed.

FIG. 4 is a view of a configuration of wireless devices performing wireless communications according to the specification. Referring to FIG. 4, a first wireless device 100 and a second wireless device 200 may transmit and receive radio signals through a variety of radio access technologies (e.g., LTE and NR). Herein, {the first wireless device 100 and the second wireless device 200} may correspond to {the wireless device 100x and the BS 200} and/or {the wireless device 100x and the wireless device 100x} of FIG. 19.

The first wireless device 100 may include at least one processor 102 and at least one memory 104 and may further include at least one transceiver 106 and/or at least one antenna 108. The processor 102 may control the memory 104 and/or the transceiver 106 and may be configured to implement the above described/proposed functions, procedures, and/or methods. For example, the processor 102 may process information inside the memory 104 to generate first information/signals and then transmit radio signals including the first information/signals through the transceiver 106. The processor 102 may receive radio signals including second information/signals through the transceiver 106 and then store information obtained by processing the second information/signals in the memory 104. The memory 104 may be connected to the processor 102 and may store a variety of information related to the operation of the processor 102. For example, the memory 104 may store software code including commands for performing some or all of processes controlled by the processor 102 or for performing the above described procedures and/or methods. Herein, the processor 102 and the memory 104 may be a part of a communication modem/circuit/chip designed to implement wireless communication technologies (e.g., LTE and NR). The transceiver 106 may be connected to the processor 102 and transmit and/or receive radio signals through at least one antenna 108. The transceiver 106 may include a transmitter and/or a receiver. The transceiver 106 may be interchangeably used with a radio frequency (RF) unit. In the disclosure, the wireless device may also refer to a communication modem/circuit/chip.

The second wireless device 200 may include at least one processor 202 and at least one memory 204 and may further include at least one transceiver 206 and/or at least one antenna 208. The processor 202 may control the memory 204 and/or the transceiver 206 and may be configured to implement the above described/proposed functions, procedures, and/or methods. For example, the processor 202 may process information inside the memory 204 to generate third information/signals and then transmit radio signals including the third information/signals through the transceiver 206. The processor 202 may receive radio signals including fourth information/signals through the transceiver 206 and then store information obtained by processing the fourth information/signals in the memory 204. The memory 204 may be connected to the processor 202 and may store a variety of information related to the operation of the processor 202. For example, the memory 204 may store software code including commands for performing some or all of processes controlled by the processor 202 or for performing the above described procedures and/or methods. Herein, the processor 202 and the memory 204 may be a part of a communication modem/circuit/chip designed to implement wireless communication technologies (e.g., LTE and NR). The transceiver 206 may be connected to the processor 202 and transmit and/or receive radio signals through at least one antenna 208. The transceiver 206 may include a transmitter and/or a receiver. The transceiver 206 may be interchangeably used with an RF unit. In the disclosure, the wireless device may also refer to a communication modem/circuit/chip.

Hereinafter, hardware elements of the wireless devices 100 and 200 will be described in more detail. At least one protocol layer may be implemented by, without being limited to, at least one processor 102 and 202. For example, the at least one processor 102 and 202 may implement at least one layer (e.g., a functional layer, such as PHY, MAC, RLC, PDCP, RRC, or SDAP). The at least one processor 102 and 202 may generate at least one protocol data unit (PDU) and/or at least one service data unit (SDU) according to the functions, procedures, proposals, and/or methods disclosed in this document. The at least one processor 102 and 202 may generate messages, control information, data, or information according to the functions, procedures, proposals, and/or methods disclosed in this document. The at least one processor 102 and 202 may generate signals (e.g., baseband signals) including PDUs, SDUs, messages, control information, data, or information according to the functions, procedures, proposals, and/or methods disclosed in this document and provide the generated signals to the at least one transceiver 106 and 206. The at least one processor 102 and 202 may receive the signals (e.g., baseband signals) from the at least one transceiver 106 and 206, and acquire the PDUs, SDUs, messages, control information, data, or information according to the functions, procedures, proposals, and/or methods disclosed in this document.

The at least one processor 102 and 202 may be referred to as a controller, microcontroller, microprocessor, or microcomputer. The at least one processor 102 and 202 may be implemented by hardware, firmware, software, or a combination thereof. As an example, at least one application specific integrated circuit (ASIC), at least one digital signal processor (DSP), at least one digital signal processing device (DSPD), at least one programmable logic device (PLD), or at least one field programmable gate array (FPGA) may be included in the at least one processor 102 and 202. The functions, procedures, proposals, and/or methods disclosed in this document may be implemented using firmware or software and the firmware or software may be configured to include modules, procedures, or functions. Firmware or software configured to perform the functions, procedures, proposals, and/or methods disclosed in this document may be included in the at least one processor 102 and 202 or stored in the at least one memory 104 and 204 so as to be driven by the at least one processor 102 and 202. The functions, procedures, proposals, and/or methods disclosed in this document may be implemented using firmware or software in the form of code, commands, and/or a set of commands.

The at least one memory 104 and 204 may be connected to the at least one processor 102 and 202 and store various types of data, signals, messages, information, programs, code, instructions, and/or commands. The at least one memory 104 and 204 may be configured by a read-only memory (ROM), random access memory (RAM), electrically erasable programmable read-only memory (EPROM), flash memory, hard drive, register, cash memory, computer-readable storage medium, and/or a combination thereof. The at least one memory 104 and 204 may be located at the interior and/or exterior of the at least one processor 102 and 202. The at least one memory 104 and 204 may be connected to the at least one processor 102 and 202 through various technologies such as wired or wireless connection.

The at least one transceiver 106 and 206 may transmit user data, control information, and/or radio signals/channels, mentioned in the methods and/or operational flowcharts of this document, to at least one other device. The at least one transceiver 106 and 206 may receive user data, control information, and/or radio signals/channels, mentioned in the functions, procedures, proposals, methods, and/or operational flowcharts disclosed in this document, from at least one other device. For example, the at least one transceiver 106 and 206 may be connected to the at least one processor 102 and 202 and transmit and receive radio signals. For example, at least one processor 102 and 202 may control the at least one transceiver 106 and 206 to transmit user data, control information, or radio signals to at least one other device. The at least one processor 102 and 202 may control the at least one transceiver 106 and 206 to receive user data, control information, or radio signals from at least one other device. The at least one transceiver 106 and 206 may be connected to the at least one antenna 108 and 208 and the at least one transceiver 106 and 206 may be configured to transmit and receive user data, control information, and/or radio signals/channels, mentioned in the functions, procedures, proposals, methods, and/or operational flowcharts disclosed in this document, through the at least one antenna 108 and 208. In this document, the at least one antenna may be a plurality of physical antennas or a plurality of logical antennas (e.g., antenna ports). The at least one transceiver 106 and 206 may convert received radio signals/channels from RF band signals into baseband signals to process received user data, control information, and/or radio signals/channels using the at least one processor 102 and 202. The at least one transceiver 106 and 206 may convert the user data, control information, and/or radio signals/channels processed using the at least one processor 102 and 202 from the base band signals into the RF band signals. To this end, the at least one transceiver 106 and 206 may include (analog) oscillators and/or filters.

In this regard, 6G wireless communication services are not only applicable to electronic devices, such as mobile terminals or image display devices. The 6G wireless communication services may be applied to electronic devices that support fully autonomous driving vehicles, artificial intelligence (AI) robots, and augmented/virtual reality (AR/VR)-based metaverses.

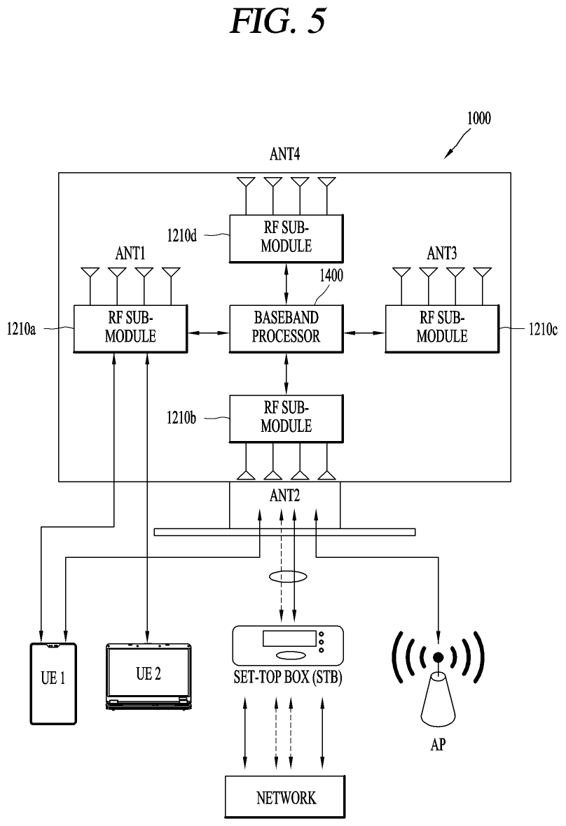

Hereinafter, an electronic device having an array antenna that may operate in an mmWave band or a terahertz band will be described. In this regard, FIG. 5 is a view of an electronic device in which a plurality of antenna modules and a plurality of transceiver circuit modules according to an embodiment are arranged. Referring to FIG. 5, an electronic device in which a plurality of antenna modules and a plurality of transceiver circuit modules are arranged may be an image display device, but is not limited thereto. Therefore, the electronic device having the plurality of antenna modules and the plurality of transceiver circuit modules disclosed herein may include an arbitrary electronic device or vehicle that supports a communication service in a millimeter wave band or a terahertz band.

Referring to FIG. 5, the electronic device 1000 includes a plurality of antenna modules ANT1 to ANT4 and a plurality of transceiver circuit modules 1210A to 1210d. In this regard, the plurality of transceiver circuit modules 1210A to 1210d may correspond to the aforementioned transceiver circuit 1250. Or, the plurality of transceiver circuit modules 1210A to 1210d may be a partial configuration of the transceiver circuit 1250 or a partial configuration of a front end module arranged between the antenna module and the transceiver circuit 1250.

The plurality of antenna modules ANT1 to ANT4 may be configured as array antennas with a plurality of antenna elements. The number of elements of each antenna module ANT1 to ANT4 may be two, three, four, and the like as aforementioned, but it not limited thereto. For example, the number of elements of each of the antenna modules ANT1 to ANT4 may be expanded to two, four, eight, sixteen, and the like. Also, the elements of the antenna modules ANT1 to ANT4 may be selected by the same number or different numbers. The plurality of antenna modules ANT1 to ANT4 may be arranged in different areas of a display or on a lower or side surface of the electronic device. The plurality of antenna modules ANT1 to ANT4 may be arranged on upper, left, lower, and right sides of the display, but are not limited to this arrangement structure. As another example, the plurality of antenna modules ANT1 to ANT4 may be arranged on an upper left portion, an upper right portion, a lower left portion, and a lower right portion of the display.

The antenna modules ANT1 to ANT4 may be configured to transmit and receive signals at an arbitrary frequency band in a specific direction. For example, the antenna modules ANT1 to ANT4 may operate at any one of 28 GHz band, 39 GHz band, 64 GHz band, or 100 GHz band.

The electronic device may maintain a connection state with different entities through two or more of the antenna modules ANT1 to ANT4 or perform data transmission or reception for maintaining the connection state. In this regard, the electronic device corresponding to the display device may transmit or receive data to or from a first entity through the first antenna module ANT1. The electronic device may transmit or receive data to or from a second entity through the second antenna module ANT2. As one example, the electronic device may transmit or receive data to or from a mobile terminal (user equipment (UE)) through the first antenna module ANT1. The electronic device may transmit or receive data to or from a control device such as a set-top box or access point (AP) through the second antenna module ANT2.

The electronic device may transmit or receive data to or from other entities through the other antenna modules, for example, the third antenna module ANT3 and the fourth antenna module ANT4. As another example, the electronic device may perform dual connectivity or MIMO with at least one of previously-connected first and second entities through the third antenna module ANT3 and the fourth antenna module ANT4.

Mobile terminals UE1 and UE2 may be arranged in a front region of the electronic device to communicate with the first antenna module ANT1. In other embodiments, the set-top box (STB) or the AP may be arranged in a lower region of the electronic device to communicate with the second antenna module ANT2 but is not limited thereto. As another example, the second antenna module ANT2 may include a first antenna radiating a signal to the lower region, and a second antenna radiating a signal to the front region. Therefore, the second antenna module ANT2 may perform communication with the set-top box (STB) or the AP through the first antenna, and perform communication with one of the mobile terminals UE1 and UE2 through the second antenna.

In some embodiments, one of the mobile terminals UE1 and UE2 may be configured to perform MIMO with the electronic device. As one example, the UE1 may be configured to perform MIMO while performing beamforming with the electronic device. As aforementioned, the electronic device corresponding to the image display device may perform high-speed communication with another electronic device or a set-top box through a WiFi radio interface. As one example, the electronic device may perform high-speed communication with another electronic device or a set-top box at a frequency band of at least 100 GHz through a 6G radio interface.

In some embodiments, the transceiver circuit modules 1210A to 1210d may operate to process transmission signals and reception signals at an RF frequency band. Here, the RF frequency band, as aforementioned, may be an arbitrary frequency band of 28 GHz band, 39 GHz band, 64 GHz, or at least 100 GHz band. In some embodiments, the transceiver circuit modules 1210A to 1210d may be referred to as RF sub-modules 1210A to 1210d. At this time, the number of RF sub-modules 1210A to 1210d may not be limited to four, but may vary to an arbitrary number more than two depending on an application. A baseband processor 1400 may be configured to control the transceiver circuit modules 1210A to 1210d.

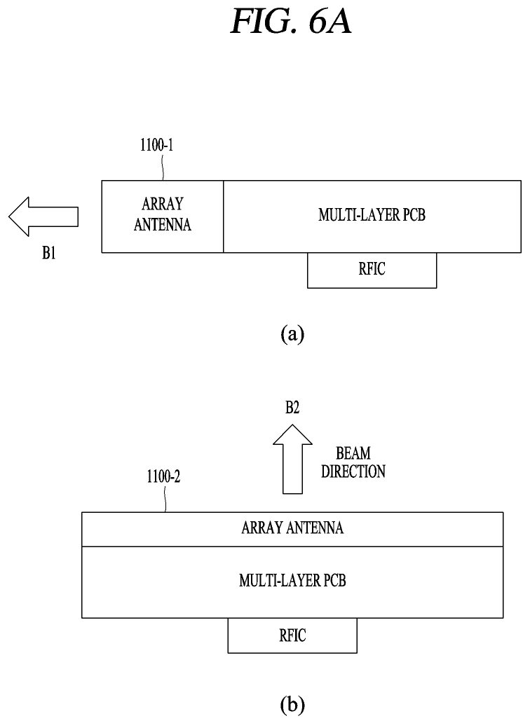

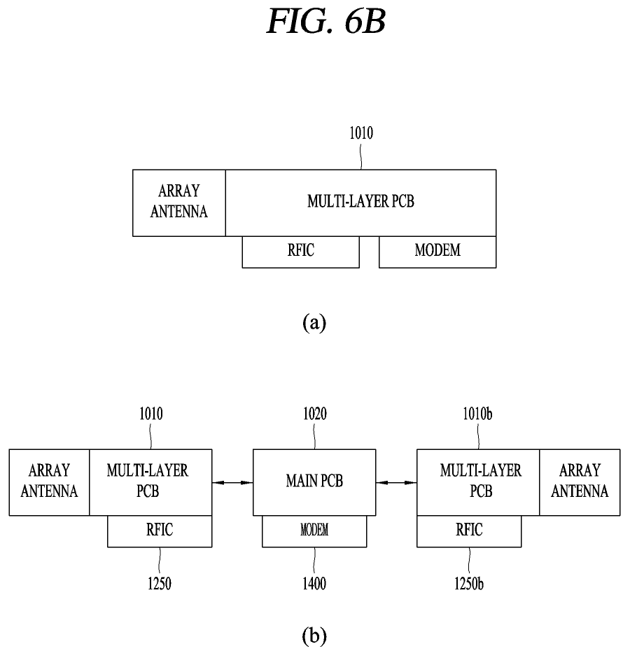

FIG. 6A is a view of a configuration, in which a multi-layer circuit board having an array antenna module arranged therein is connected to an RFIC, in relation to THz band communication according to the specification. Referring to (a) of FIG. 6A, the antenna module may be arranged for mmWave or THz band communication, and may be configured in an integral form of RFIC-PCB-antenna. In this regard, an array antenna module 1100-1, as illustrated in (a) of FIG. 6A, may be formed integrally with a multi-layer PCB. The array antenna module 1100-1 may be arranged in one side region of the multi-layer PCB. Accordingly, a first beam B1 may be formed toward the side region of the multi-layer PCB by using the array antenna module 1100-1 arranged in the one side region of the multi-layer PCB. Referring to (b) of FIG. 6A, an array antenna module 1100-2 may be arranged on top of the multi-layer PCB. A second beam B2 may be formed toward a front region of the multi-layer PCB by using the array antenna module 1100-2.

The first array antenna 1100-1 of (a) of FIG. 6A may be arranged in the side region of the multi-layer PCB and the second array antenna 1100-2 of (b) of FIG. 6A may be arranged in the side region of the multi-layer PCB. Accordingly, the first beam B1 may be generated through the first array antenna 1100-1 and the second beam B2 may be generated through the second array antenna 1100-2.

The first array antenna 1100-1 and the second array antenna 1100-2 may be configured to be in the same polarization. Or, the first array antenna 1100-1 and the second array antenna 1100-2 may be configured to be in orthogonal polarizations to each other. In this regard, the first array antenna 1100-1 may operate as a vertically polarized antenna or operate as a horizontally polarized antenna.

In some embodiments, a multi-layer PCB in which an array antenna is arranged may be integrally formed with a main substrate or may be modularly coupled to the main substrate by a connector. In this regard, FIG. 6B is a view of coupling structures between a multi-layer substrate and a main substrate according to embodiments. Referring to (a) of FIG. 6B, a structure in which an RFIC 1250 and a modem 1400 are integrally formed on a multi-layer PCB 1010 is illustrated. The modem 1400 may be referred to as a baseband processor 1400. Therefore, the multi-layer PCB 1010 may be integrally formed with the main substrate. The integral structure may be applied to a structure in which only one array antenna module is arranged in an electronic device.

In some examples, the multi-layer PCB 1010 and the main substrate 10120 may be modularly coupled to each other by a connector. Referring to (b) of FIG. 6B, the multi-layer PCB 1010 may be interfaced with the main substrate 1020 through the connector. In this instance, the RFIC 1250 may be arranged on the multi-layer PCB 1010 and the modem 1400 may be arranged on the main substrate 1020. Accordingly, the multi-layer PCB 1010 may be produced as a separate substrate from the main substrate 1020 and coupled to the main substrate 1020 through the connector.

The modular structure may be applied to a structure in which a plurality of array antenna modules are arranged in an electronic device. Referring to (b) of FIG. 6B, the multi-layer PCB 1010 and a second multi-layer PCB 1020 may be configured to interface the main substrate 1020 through connectors. The modem 1400 arranged on the main substrate 1020 may be electrically coupled to RFICs 1250 and 1250b, which are arranged on the multi-layer PCB 1010 and the second multi-layer PCB 1020.

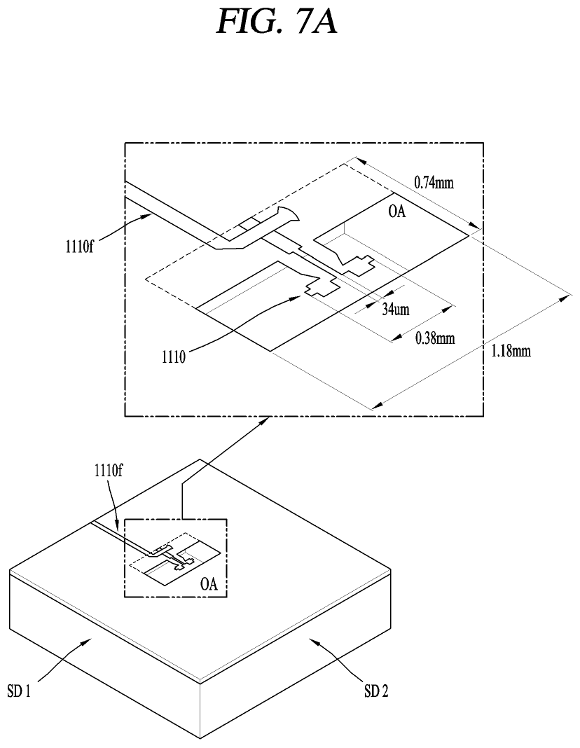

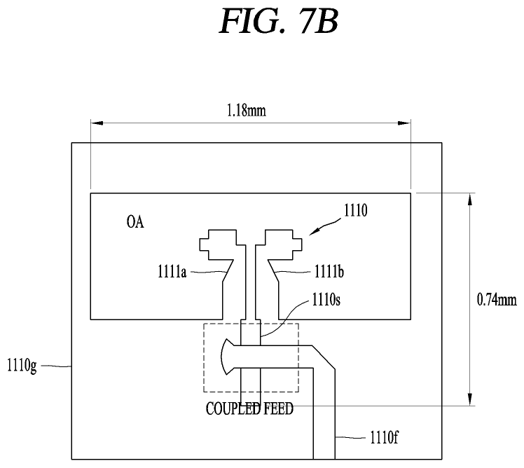

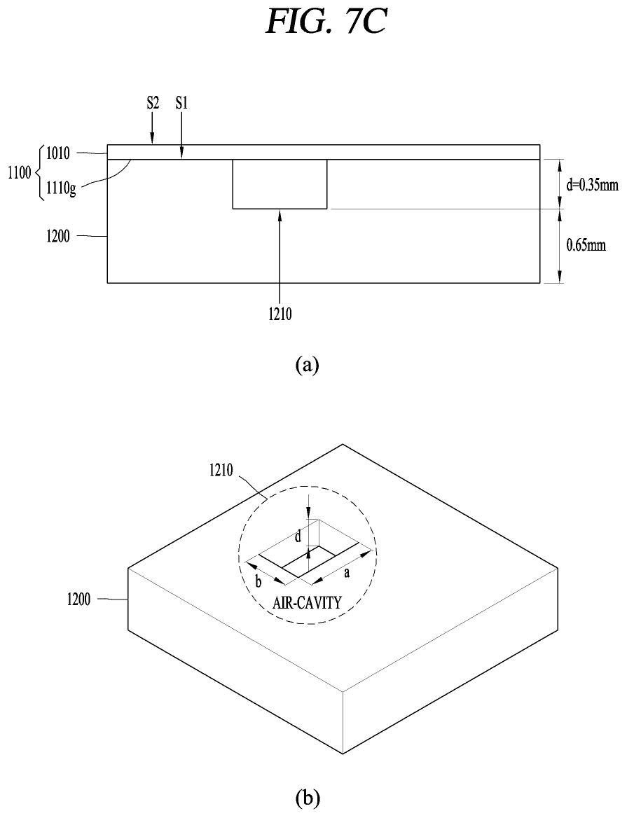

Hereinafter, a cavity-backed microstrip dipole antenna array that performs 6G wireless communication and an electronic device including the same are described. In detail, a cavity-backed microstrip dipole antenna structure according to the specification is described. In this regard, FIGS. 7A to 7C illustrate a microstrip dipole antenna having a single cavity-backed structure. FIG. 7A is an enlarged perspective view of a partial region of the microstrip dipole antenna having a single cavity-backed structure. FIG. 7B is a front view of the microstrip dipole antenna having a single cavity-backed structure. FIG. 7C illustrates a side view of the microstrip dipole antenna with a single cavity-backed structure and a view of a structure in which a cavity is arranged in a substrate.

Referring to FIGS. 7A to 7C, a dipole antenna structure may be configured to include the PCB 1100 and a metal substrate (metallic substrate) 1200. The metal substrate 1200 may be arranged in a region below the PCB 1100. The metal substrate 1200 may have a metal structure as a whole, but is not limited thereto and may include a hollow metal structure or a metal structure with only a surface plated to a constant thickness.

The PCB 1100 and the metal substrate 1200 may be referred to as a first substrate and a second substrate, respectively. The PCB 1100 may be configured as a silicon substrate, and the metal substrate 1200 may have a surface made of a metal material. A permittivity of the PCB 1100 implemented as a silicon substrate may be configured to be about 11.7, and a thickness of the PCB 1100 may be configured to be about 80 um. A thickness of the metal substrate 1200 may be configured to be about 1 mm.

The PCB 1100 may be configured to include a dielectric substrate 1010, a ground 1110g, and a radiator 1110. The PCB 1100 may be configured to further include a microstrip feeder 1110f and a conductive pattern 1120. The dielectric substrate 1010 may have a metal layer arranged on a first surface S1 which is a rear surface and a second surface S2 which is a front surface. The radiator 1110 and the ground 1110g may be located on the first surface S1 of the dielectric substrate 1010. The microstrip feeder 1110f may be arranged on the second surface S2 of the dielectric substrate 1010. The microstrip feeder 1110f is implemented to have a characteristic impedance of 50 ohm and constitutes a feeding structure using coupling with a slot 1100s on the first surface S1.

The radiator 1110 may be configured to include a first radiator pattern 1111a and a second radiator pattern 1111b. A length along one axis of the radiator 1110 may be configured to be about 0.38 mm. The first radiator pattern 1111a and the second radiator pattern 1111b may be arranged to be spaced apart from each other by a predetermined gap, for example, about 34 μm. The ground 1110g may include an open area OA. The radiator 1110 may be placed within the open area OA. A length along one axis of the open area OA may be configured to be about 1.18 mm. An end of the open area OA may extend in a direction of another axis to be coupled by the microstrip feeder 1110f. A length on the another axis of the open area OA may be configured to be about 0.74 mm.

A cavity 1210 may be arranged in the metal substrate 1200 corresponding to a region on which the radiator 1110 is arranged. A depth of the cavity 1210 may be configured to be about 0.35 mm. A thickness of the metal substrate 1200 placed below the PCB 1100 which is a silicon substrate may be configured to be about 1 mm, and a thickness from a lower end of the cavity 1210 to a lower end of the metal substrate 1200 may be configured to be about 0.65 mm. The cavity 1210 may be arranged to correspond to a region in which the open area OA of the ground 1110g is arranged. The cavity 1210 may be configured to have a length of 1.18×0.74 mm in directions of one axis and another axis. The cavity 1210 may be arranged in the metal substrate 1200 to be capable of improving antenna directivity and an antenna gain.

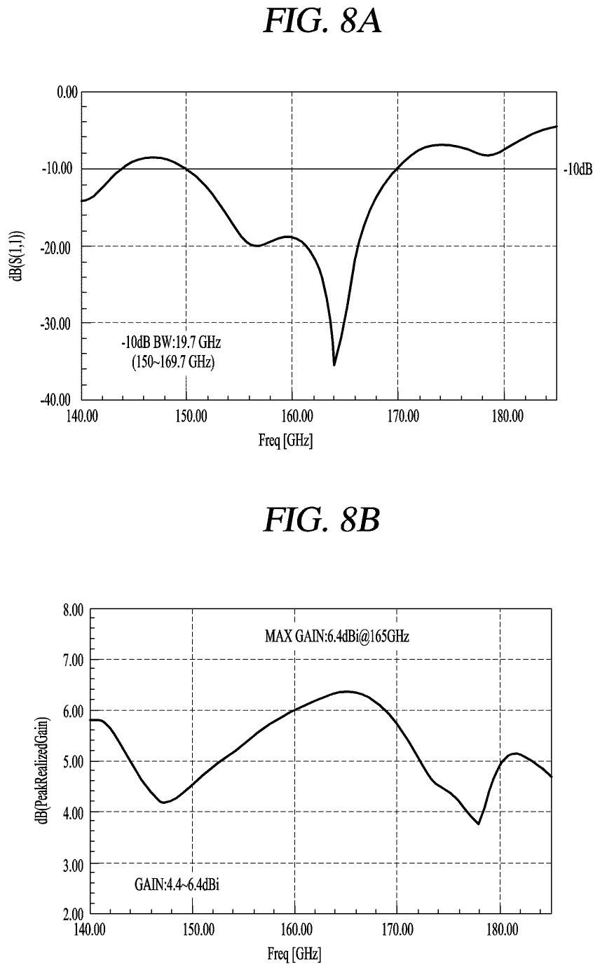

Hereinafter, performance of a microstrip dipole antenna having such a single cavity structure is described. FIGS. 8A and 8B show reflection coefficients and gain characteristics of a microstrip dipole antenna having a single cavity-backed structure. Referring to FIG. 8A, a reflection coefficient bandwidth of the microstrip dipole antenna with the single cavity-backed structure may be configured to be 19.7 GHz, i.e., from 150 to 169.7 GHz with reference to −10 dB or less. Referring to FIG. 8B, a radiation gain in a 6G frequency band of a D-band has a value of about 4.4 to 6.4 dBi. At a center frequency of 160 GHz, a radiation gain has a value of about 6.0 dBi, and a maximum radiation gain has a value of 6.4 dBi at 165 GHz. The 6G frequency band of the D-band may be set to about 151 to 175 GHz. Meanwhile, the microstrip dipole antenna having the single cavity-backed structure may have a radiation pattern arranged to have directivity in a direction perpendicular to a horizontal surface on which the dipole antenna is placed.

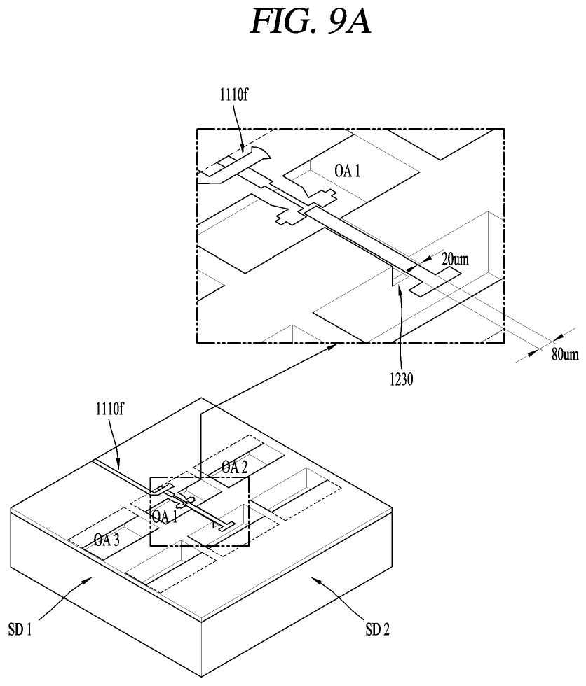

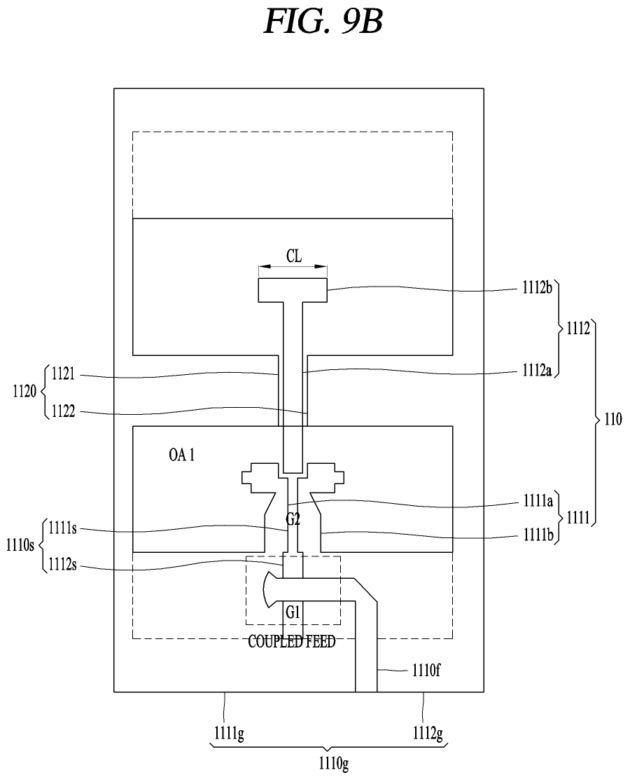

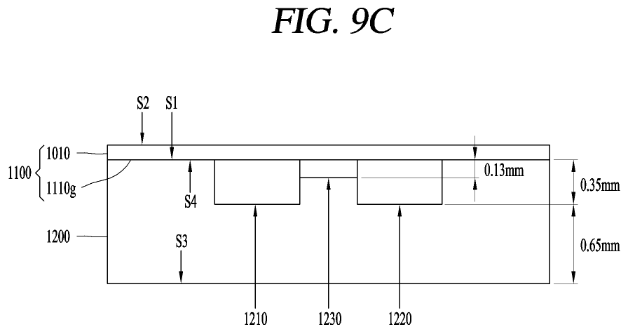

Meanwhile, a microstrip dipole antenna having a cavity-backed structure according to the specification may be configured to include a plurality of cavity-backed structures. In this regard, FIGS. 9A to 9C illustrate a microstrip dipole antenna having a plurality of cavities according to the specification arranged therein. FIG. 9A is a perspective view of a microstrip dipole antenna structure and an enlarged view of a partial region thereof. FIG. 9B is a front view of the microstrip dipole antenna structure of FIG. 9A. FIG. 9C is a side view of a microstrip dipole antenna structure in which a plurality of cavities are arranged in the antenna structure of FIG. 9A.

Referring to FIGS. 9A to 9C, a dipole antenna structure of a cavity-backed microstrip dipole antenna array is described. The dipole antenna structure may be configured to include the PCB 1100 and the metal substrate (metallic substrate) 1200. The metal substrate 1200 may be arranged in a region below the PCB 1100. The PCB 1100 and the metal substrate 1200 may be referred to as a first substrate and a second substrate, respectively.

The PCB 1100 may be configured to include the dielectric substrate 1010, the ground 1110g, and radiators 1110. The PCB 1100 may be configured to further include the microstrip feeder 1110f and the conductive pattern 1120.

The dielectric substrate 1010 may include the first surface S1 and the second surface S2. The second surface S2 may be at an opposite side to the first surface S1. The first surface S1 and the second surface S2 may constitute a rear surface and a front surface of the dielectric substrate 1010, respectively. The ground 1110g may be placed on the second surface S2 of the dielectric substrate 1010. The ground 1110g may include a first open area OA1, a second open area OA2, and a third open area OA3. The first open area OA1 may be placed to have the second open area OA2 and the third open area OA3 arranged at one side and another side, respectively.

The radiators 1110 may be placed in the first open area OA1 in a central portion of the second surface S2 of the dielectric substrate 1010. A first end of each of the radiators 1110 may be connected to a part of the ground 1110g. The microstrip feeder 1110f may be placed on the first surface S1 of the dielectric substrate 1010. A part of the ground 1110g may be electrically coupled to the microstrip feeder 1110f. The microstrip feeder 1110f arranged on the first surface S1 of the dielectric substrate 1010 may be electrically coupled to the slot 1100s on the first surface S1 of the dielectric substrate 1010 to be coupled-fed to the radiators 1110. The conductive pattern 1120 may be arranged on the second surface S2 of the dielectric substrate 1010. The conductive pattern 1120 may be electrically coupled to a second end of each of the radiators 1110. The radiators 1110 and the conductive pattern 1120 are not directly connected to each other, but spaced apart from each other by a predetermined gap to couple signals of the radiators 1110 to the conductive pattern 1120. Since the radiators 1110 and the conductive pattern 1120 are each connected to the ground 1110g, the radiators 1110 and the conductive pattern 1120 are not directly connected to each other, but are connected through the ground 1110g.

The metal substrate 1200 may include a third surface S3 and a fourth surface S4. The fourth surface S4 may be at an opposite side to the third surface S3. The third surface S3 and the fourth surface S4 may constitute a rear surface and a front surface of the metal substrate 1200, respectively. The fourth surface S4 of the metal substrate 1200 may be arranged to be faced with the first surface S1 of the dielectric substrate 1010. The metal substrate 1200 may be configured to have a height greater than a height of the dielectric substrate 1010. The height of the metal substrate 1200 may be configured to be greater so that a plurality of cavities may be arranged in the metal substrate 1200. For example, the metal substrate 1200 may be configured to have a height of 1.0 mm. Meanwhile, the dielectric substrate 1010 may be configured to have a height of 80 um.

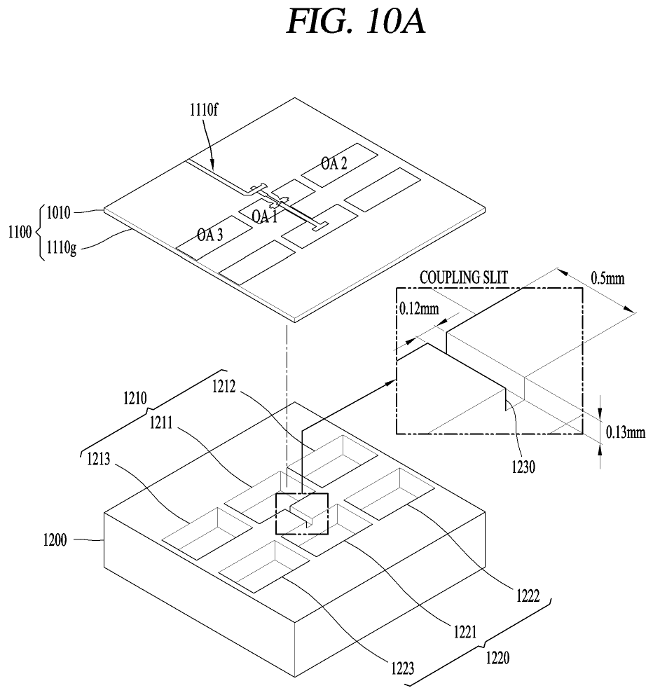

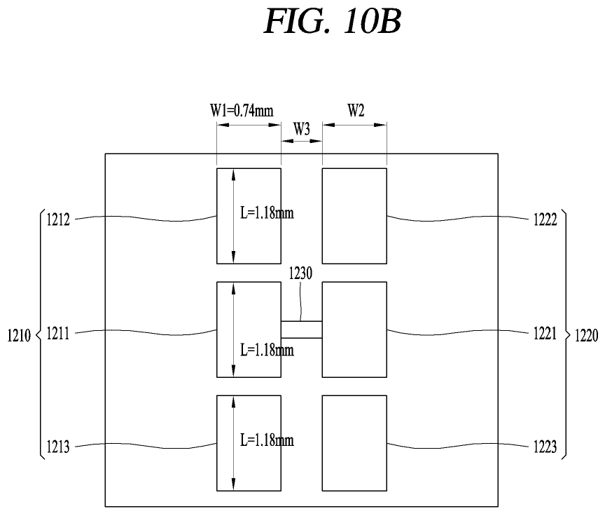

A plurality of cavities may be arranged on radiators and regions in a periphery of the radiators on the metal substrate 1200. In this regard, FIGS. 10A and 10B illustrate an exploded perspective view and a front view of an antenna structure in which a plurality of cavities are arranged in a dielectric substrate according to an embodiment of the specification, respectively. FIG. 10A is an exploded perspective view of an antenna structure in which a plurality of cavities are arranged in a dielectric substrate according to an embodiment of the specification, and an enlarged view of a third cavity. FIG. 10B is a front view of a plurality of cavities arranged in the dielectric substrate of the antenna structure of FIG. 10A.

Referring to FIGS. 9A to 10B, the metal substrate 1200 may be configured to include a first cavity 1210, a second conductive pattern 1220, and a third cavity 1230. The first cavity 1210 may be arranged on the fourth surface S4 of the metal substrate 1200. The first cavity 1210 may be arranged in a position overlapping the radiators 1110 and a first part of the conductive pattern 1200. The second cavity 1220 may be arranged on the fourth surface S4 of the metal substrate 1200. The second cavity 1220 may be arranged at a position overlapping a second part of the conductive pattern 1200. The third cavity 1230 may be arranged on the fourth surface S4 of the metal substrate 1200. The third cavity 1230 may be arranged at a position overlapping a middle part between the first part 1121 and the second part 1122 of the conductive pattern 1120.

The third cavity 1230 may be arranged to be connected the first cavity 1210 and the second cavity 1220. The third cavity 1230 may be arranged between the first cavity 1210 and the second cavity 1220. A size, a shape, and a depth of the first cavity 1210 may be configured to be identical to a size, a shape, and a depth of the second cavity 1220.

An inner side of the first cavity 1210, an inner side of the second cavity 1220, and an inner side of the third cavity 1230 may be composed of air. Accordingly, radiation efficiency of signals radiated from the radiators 1110 may be improved by preventing a propagation loss by a surface wave generated in the dielectric region 1010 on which the radiators 1110 are placed. The surface wave generated in the dielectric region 1010 may be radiated upward the radiators 1110 through the inner side of the first cavity 1210, the inner side of the second cavity 1220, and the inner side of the third cavity 1230.

At least one inner side among the inner side of the first cavity 1210, the inner side of the second cavity 1220, and the inner side of the third cavity 1230 may be configured to have a dielectric structure. In this regard, a permittivity of the dielectric structure associated with a cavity may be set to a lower value than that of a permittivity of the metal substrate 1200. Since the permittivity of the dielectric structure associated with a cavity is set to be lower than the permittivity of the metal substrate 1200, radiation efficiency may be improved.

As described above, the ground 1110g may constitute the open area OA1. The radiators 1110 may be located in the open area OA1. A first cavity 1211 and a second cavity 1221 may be arranged to correspond to the open area OA1. Accordingly, radiation efficiency of the radiators 1110 located in the open area OA1 may be improved. The second open area OA2 and the third open area OA3 may be arranged at one side and another side of the open area OA1 to be adjacent to the open area OA1. Accordingly, first cavities 1212 and 1213 and second cavities 1222 and 1223 may be located to correspond to the second open area OA2 and the third open area OA3. Accordingly, surface waves in one side and another side areas of the radiators 1110 may be radiated upward in the second and third open areas OA2 and OA3, thereby improving radiation efficiency.

The open area OA of the ground 1110g may be configured to have a size smaller than a size of the first cavity 1211. The second and third open areas OA2 and OA3 of the ground 1110g may also be configured to have smaller sizes than sizes of the first cavities 1212 and 1213. The first cavities 1211 to 1213 may be configured to have sizes greater than sizes of the first to third open areas OA1 to OA3 of the ground 1110g. Surface waves generated in the first to third open areas OA1 to OA3 of the ground 1110g may be received inside the first cavities 1211 to 1213 and propagated to an upper region of the radiators 1110. Accordingly, surface wave components generated in a boundary region of the first to third open areas OA1 to OA3 of the ground 1110g may be propagated to the upper region of the radiators 1110, thereby improving radiation efficiency.

The first cavity 1210 and the second cavity 1220 may be arranged in one axial direction to correspond to the first to third open areas OA1 to OA arranged on the ground 1110g of the PCB 1000 arranged upwards. The first cavity 1210 and the second cavity 1220 may be each arranged as three pieces at a central region and at one side region and another side region adjacent to the central region in a horizontal direction. The first cavity 1210 may include a plurality of the cavities 1211 to 1213 arranged spaced apart from each other in one axial direction. The second cavity 1220 may include a plurality of the cavities 1221 to 1223 arranged spaced apart from each other in one axial direction.

Meanwhile, the third cavity 1230 may be configured as a single structure only in the central region. The third cavity 1230 may be arranged to be connected to the first cavity 1211 and the second cavity 1221 each arranged in the central region. The third cavity 1230 may be configured to connect the first cavity 1211 and the second cavity 1221 each in the central region in which a radiator 1110 is placed. A second radiator 1112 corresponding to a coupling pattern may be placed in a region in which the third cavity 1230 is arranged. Accordingly, the third cavity 1230 in which the coupling pattern is arranged may be referred to as a coupling slit. A size and a depth of the third cavity 1230 may be configured to be smaller than a size and a depth of the first cavity 1210 or the second cavity 1220. A size of the third cavity 1230 may be configured to be 0.12×0.5 mm in horizontal and vertical directions.

The first cavity 1210 and the second cavity 1220 may be each configured to have a predetermined length L in one axial direction. The first cavity 1210 may be configured to have a first width W1 in another axial direction. The second cavity 1220 may be configured to have a second width W2 in another axial direction. The first width W1 of the first cavity 1210 and the second width W2 of the second cavity 1220 may be set to have a same value, but are not limited thereto. Antenna performance may be changed depending on a change in the length L of each of the first cavity 1210 and the second cavity 1220.

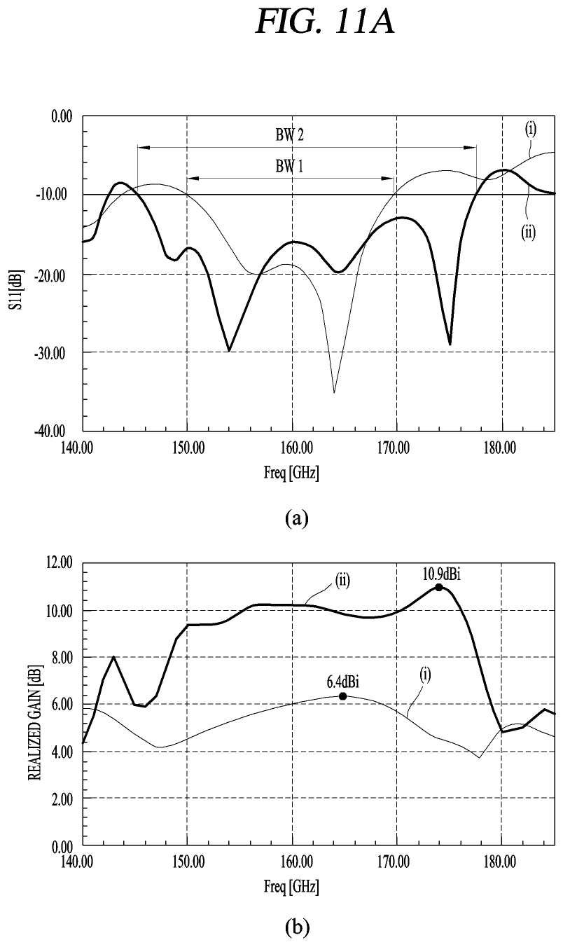

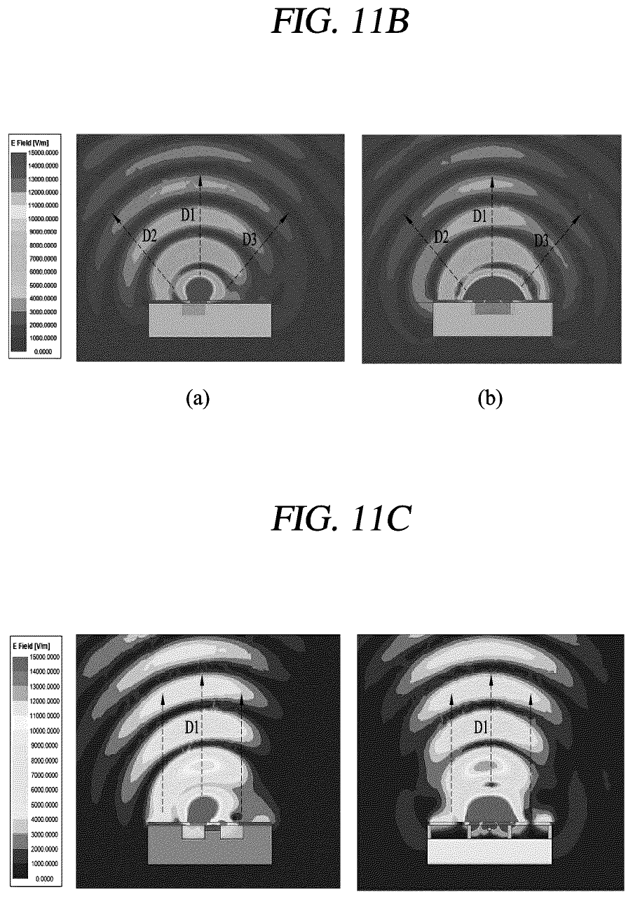

Hereinafter, characteristics of an antenna having the single cavity structure of FIGS. 7A to 7C and an antenna having the multi-cavity structure of FIGS. 9A to 9C are described. In this regard, FIG. 11A shows comparison between reflection coefficients and radiation gains of an antenna having the single cavity structure and an antenna having the multi-cavity structure, respectively. Referring to FIG. 8A and (a) of FIG. 11A, (i) a reflection coefficient of an antenna having the single cavity structure is dual-resonant with reference to a center frequency and operates as a radiator within a first bandwidth BW1 with reference to −10 dB. Dual resonance characteristics are generated by a first resonance mode of a dipole antenna and a second resonance mode of the single cavity structure.

Referring to (b) of FIG. 11A, (ii) a reflection coefficient of an antenna having the single cavity structure is multi-resonant with reference to a center frequency and operates as a radiator within a second bandwidth BW2 wider than the first bandwidth BW1 with reference to −10 dB. Multi-resonance characteristics are generated by the first resonance mode of the dipole antenna and second to fourth resonance modes of the first to third cavities.

In this regard, the cavity 1210 of (b) of FIG. 7C may be configured to have lengths a and b in directions of one axis and another axis and have a depth of d. When the cavity 1210 is configured to have the lengths and depths of a, b, and d in the directions of the one axis and the another axis, respectively, a resonance frequency of a resonance mode generated by the cavity 1210 may be determined as shown in Equation 1.

$${f}_{mnl} = \frac{c}{2 π \sqrt{{μ}_{r} {ε}_{r}}} {k}_{mnl} = \frac{c}{2 \sqrt{{μ}_{r} {ε}_{r}}} √ {( \frac{m}{a} )}^{2} + {( \frac{n}{b} )}^{2 +} {( \frac{l}{d} )}^{2} \qquad [ Equation 1 ]$$

Here, m, n, and l are wave numbers determined by a resonance mode, and when values of a, b, and d are determined, a resonant frequency may be derived by Equation 1. In addition, c is a speed of light, and Fr and r represent a relative permittivity and a relative permeability, respectively. Dual resonance characteristics may be implemented by setting a resonance frequency of a single cavity to be close to a resonance frequency of a dipole antenna. Multi-resonance characteristics may be implemented by setting second to fourth resonance frequencies of multi-cavities to be close to a resonance frequency of the dipole antenna.

Referring to FIG. 8B and (b) of FIG. 11A, (i) a radiation gain of an antenna having a single cavity structure has a maximum value of 6.4 dBi. On the other hand, (ii) a radiation gain of an antenna having a multi-cavity structure has a maximum value of 10.9 dBi, which indicates a gain of approximately 4.5 dB higher than (i) the radiation gain of the antenna having the single cavity structure. The multi-cavity structure improves directivity of a dipole antenna, thereby increasing radiation efficiency.

Meanwhile, to compare a single cavity structure to a multi-cavity structure, electric field distributions of an antenna module adopting the single cavity structure and an antenna module adopting the multi-cavity structure are compared. In this regard, FIGS. 11B and 11C show electric field distributions in an antenna having a single cavity structure and an antenna having a multi-cavity structure in first and second side directions, respectively.

Referring to FIG. 7A, (a) of FIG. 11B, and (b) of FIG. 11B, electric field distributions in a single cavity antenna module in a first side direction SD1 and a second side direction SD2 are shown. A cavity-backed dipole antenna using a single cavity structure is a structure in which a first resonance mode of a dipole antenna and a second resonance mode of a cavity are combined with each other to radiate. A signal is radiated in a first direction D1 perpendicular to the dipole antenna, but a signal is also radiated in a second direction D2 and a third direction D3 each different from the first direction. Accordingly, an electric field is still scattered in a great width, thereby preventing formation of a beam pattern having directivity. Therefore, there is a need to further improve a radiation gain of an antenna in a single cavity structure.

Referring to FIG. 9A, (a) of FIG. 11C, and (b) of FIG. 11C, electric field distributions in the first side direction SD1 and the second side direction SD2 of a multi-cavity antenna module are shown. An electric field may be coupled-fed to cavity structures placed adjacent to a single cavity structure to generate a resonant mode to be utilized as an additional radiated source. An electric field generated by an additional cavity structure and an electric field generated by a dipole antenna are synthesized to concentrate a beam in the first vertical direction D1. When electric fields between a plurality of cavities are not properly synthesized, it is difficult to obtain an effect of a gain increase.

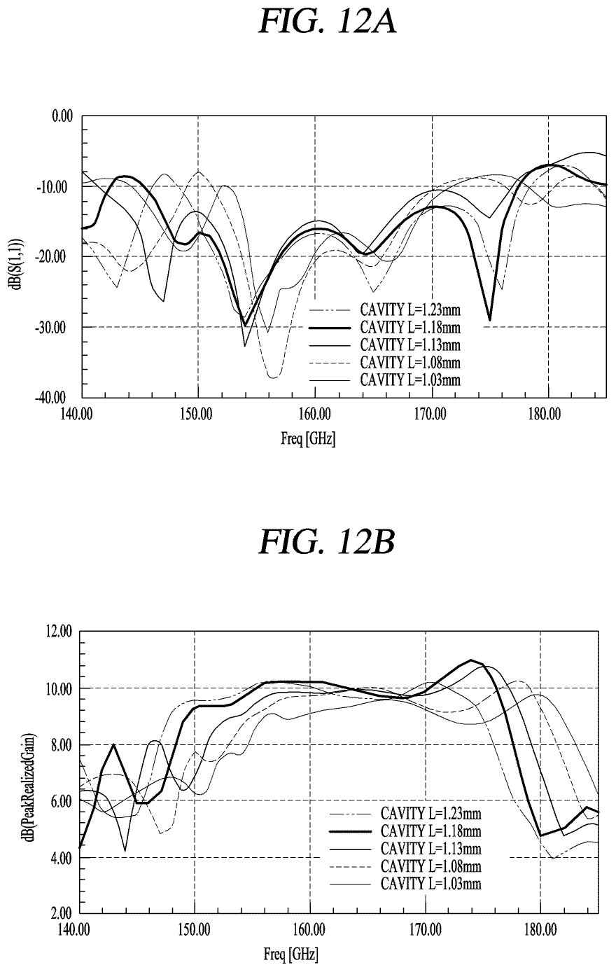

Meanwhile, FIGS. 12A and 12B show simulation results of reflection coefficient characteristics and radiation gain characteristics of an antenna in a structure in which a plurality of cavities of FIG. 10B are configured to have a same length.

Referring to FIG. 10B and FIG. 12A, as lengths L of the first cavity 1210 and the second cavity 1220 increase, an operating band of an antenna shifts to a low frequency band. As the lengths L of the first cavity 1210 and the second cavity 1220 decrease, an operating band of the antenna shifts to a high frequency band. Referring to FIGS. 10B and 12B, when the lengths L of the first cavity 1210 and the second cavity 1220 are 1.18 mm and 1.23 mm, respectively, a reflection coefficient characteristic of −10 dB or less is obtained at 151 to 175 GHz. In this regard, a whole frequency band for 6G communications is 151 to 175 GHz. Referring to FIGS. 10B and 12B, when the lengths L of the first cavity 1210 and the second cavity 1220 are 1.18 mm and 1.23 mm, respectively, the antenna has a high antenna gain characteristic of about 8 dB or more at 151 to 175 GHz. It may be understood that when the lengths L of the first cavity 1210 and the second cavity 1220 are 1.03 mm to 1.13 mm, respectively, an antenna gain in a band of 151 to 160 GHz is reduced to a certain extent compared to when the lengths L are 1.18 mm and 1.23 mm.

The first cavity 1210 and the second cavity 1220 may be each configured to have a size of 1.18×0.74 mm in horizontal and vertical directions. The first cavity 1210 and the second cavity 1220 may be each configured to have a depth of 0.35 mm. The third cavity 1230 may be configured to have a depth of 0.13 mm. One of the first cavity 1210 and the second cavity 1220 may be configured to have a width of 0.74 mm, and another may be configured to have a width of a different value.

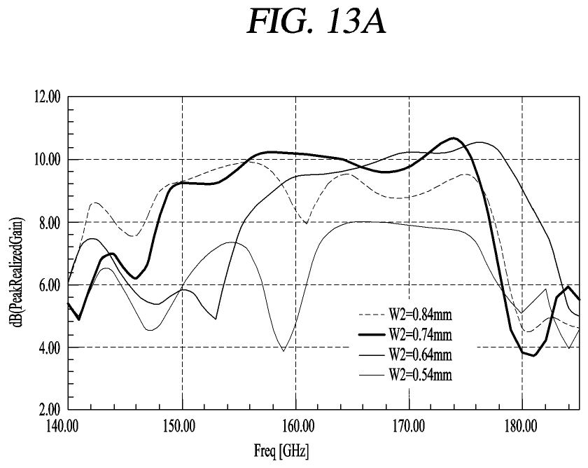

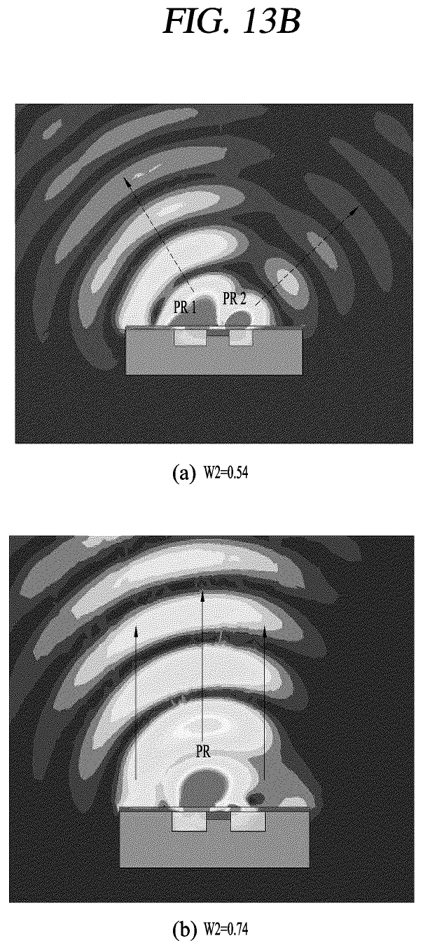

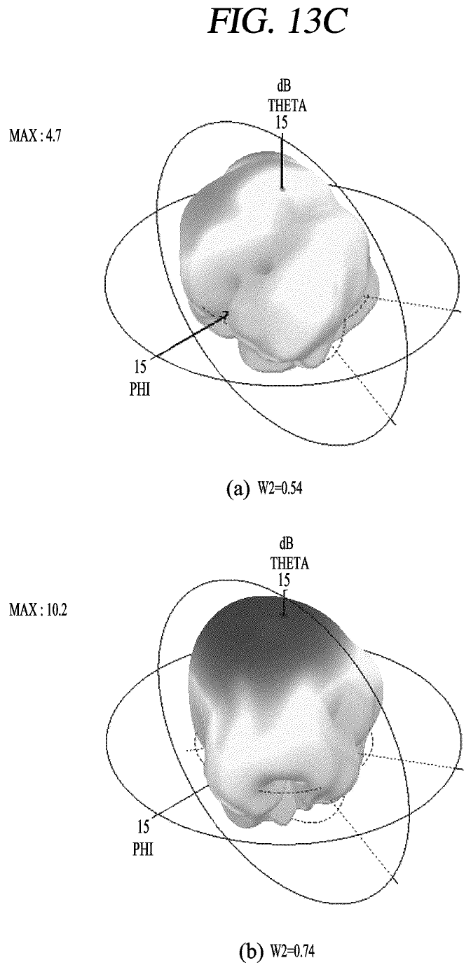

In relation to this, FIG. 13A shows antenna radiation gain characteristics according to a width of a second cavity. FIG. 13B shows electric field distribution of an antenna structure having second cavities with different width values. FIG. 13C shows a three-dimensional (3D) radiation pattern of the antenna structure having the second cavities with different width values of FIG. 13B.

Referring to FIG. 10B and FIG. 13A, when the width W2 of the second cavity 1220 is set to 0.54 mm, the antenna structure has an antenna gain value of 8 dB or less in a whole frequency band. When the width W2 of the second cavity 1220 is set to 0.64 mm, the antenna structure has an antenna gain value of 8 dB or less in a frequency band of 155 GHz or less. When the width W2 of the second cavity 1220 is set to 0.74 mm, the antenna structure has an antenna gain value of 8 dB or more. When the width W2 of the second cavity 1220 is set to 0.84 mm, the antenna structure has an antenna gain value of 8 dB or more. However, when the width W2 is 0.84 mm, an antenna gain value in a band of 161 GHz decreases to a certain extent, and thus frequency selective characteristics are obtained. Accordingly, the width W2 of the second cavity 1220 may also be set to 0.84 mm, which is identical to the width W1 of the first cavity 1210.

Referring to FIG. 10B and (a) of FIG. 13B, when the width W2 of the second cavity 1220 is set to 0.54 mm, a first peak region PR1 and a second peak region PR2 of electric field distribution of the antenna structure are defined in the first direction and the second direction, which are different directions. When the width W2 of the second cavity 1220 is 0.54 mm, an electric field generated by the second cavity 1220 is not synthesized in phase with an electric field generated by a dipole antenna, thus deteriorating radiation gain performance.

(a) of FIG. 13C shows a 3D radiation pattern of the antenna structure when the width W2 of the second cavity 1220 is 0.54 mm. Referring to FIG. 10B, (a) of FIG. 13B, and (a) of FIG. 13C, when the width W2 of the second cavity 1220 is 0.54 mm, a radiation pattern component by the second cavity 1220 and a radiation pattern component by a dipole antenna are not synthesized but separated. Therefore, when the width W2 of the second cavity 1220 is 0.54 mm, phases of electric field components or phases of radiation pattern components of the cavity and the dipole antenna are not synthesized in phase. Accordingly, when the width W2 of the second cavity 1220 is 0.54 mm, deterioration in antenna performance occurs.

Referring to FIG. 10B and (b) of FIG. 13B, when the width W2 of the second cavity 1220 is set to 0.74 mm, the peak region PR of the electric field distribution of the antenna structure is defined in a same direction. When the width W2 of the second cavity 1220 is set to 0.74 mm, the peak region PR of the electric field distribution of the antenna structure is defined in a direction perpendicular to the antenna structure. Accordingly, when the width W2 of the second cavity 1220 is 0.74 mm, an electric field generated by the second cavity 1220 may be synthesized in phase with an electric field generated by the dipole antenna. The electric field generated by the second cavity 1220 is synthesized in phase with the electric field generated by the dipole antenna, thereby improving radiation gain performance.

(b) of FIG. 13C shows a 3D radiation pattern of the antenna structure when the width W2 of the second cavity 1220 is 0.74 mm. Referring to FIG. 10B, (a) of FIG. 13B, and (b) of FIG. 13C, when the width W2 of the second cavity 1220 is 0.74 mm, a radiation pattern component by the second cavity 1220 and a radiation pattern component by a dipole antenna are synthesized with each other in a direction perpendicular to the antenna structure. A peak value of a radiation pattern (b) of FIG. 11C when the width W2 of the second cavity 1220 is 0.74 mm is greater than a peak value of a radiation pattern of (a) of FIG. 11C when the width W2 of the second cavity 1220 is 0.54 mm. Therefore, when the width W2 of the second cavity 1220 is 0.74 mm, phases of electric field components or phases of the radiation pattern component of the cavity and the dipole antenna are vertically synthesized in phase, thereby improving directivity. Accordingly, when the width W2 of the second cavity 1220 is 0.74 mm, a peak value of a radiation pattern is increased, thereby improving antenna performance. In addition, when the width W2 of the second cavity 1220 is 0.74 mm, a radiation pattern is generated in a left-right symmetrical shape with respect to a vertical direction, thereby improving antenna performance.

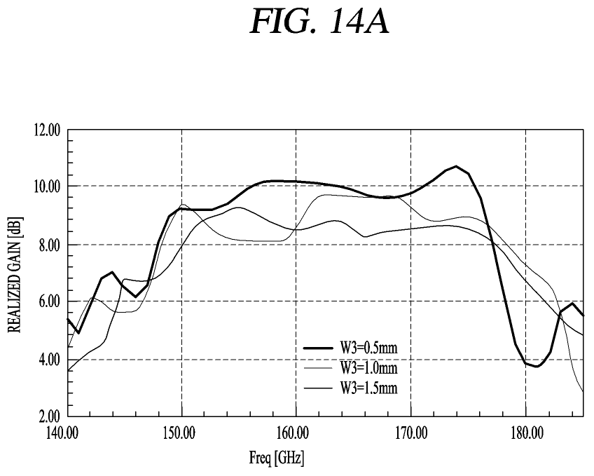

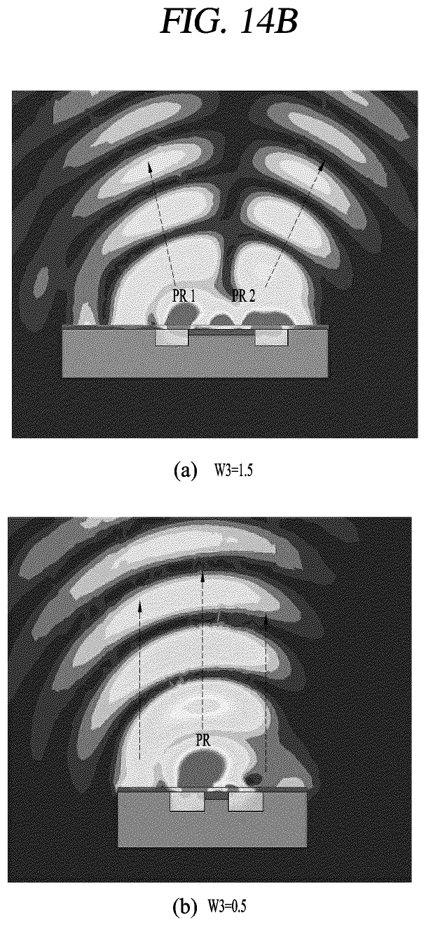

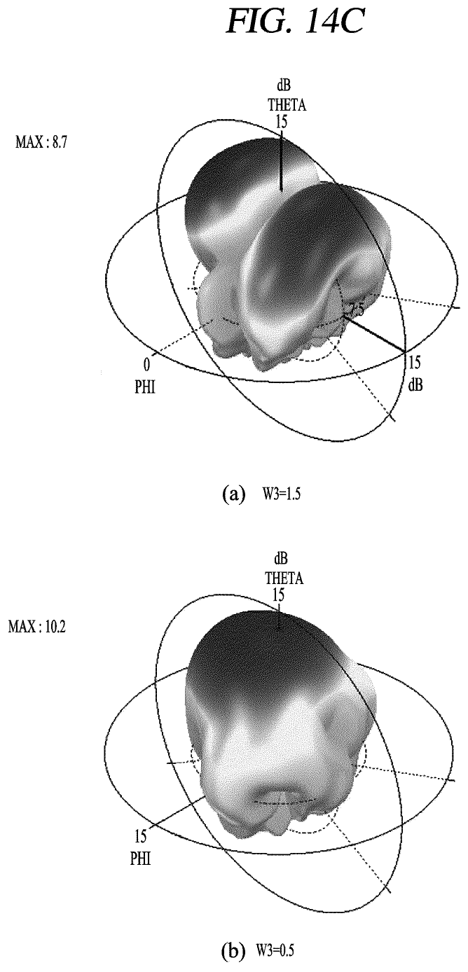

Antenna performance may be improved by adjusting a gap between the first cavity 1210 and the second cavity 1220. As a gap between the first cavity 1210 and the second cavity 1220 is changed, a width W3 of the third cavity 1230 connected to the first cavity 1210 and the second cavity 1220 is changed. In this regard, FIG. 14A shows antenna radiation gain characteristics according to a change in a gap between first and second cavities. FIG. 14B shows electric field distribution of an antenna structure having first and second cavities with different gap values. FIG. 14C shows a 3D radiation pattern of the antenna structure having the first and second cavities with the different gap values of FIG. 14B. Hereinafter, a gap between the first cavity 1210 and the second cavity 1220 is referred to as the width W3 of the third cavity 1230.

Referring to FIG. 10B and FIG. 14A, when the width W3 of the third cavity 1230 is set to 1.5 mm, the antenna structure has an antenna gain value reduced to a certain degree in some frequency bands of 160 GHz or less. When the width W3 of the third cavity 1230 is set to 1.0 mm, the antenna structure has an antenna gain value reduced to a certain degree in some frequency bands of 160 GHz or higher. When the width W3 of the second cavity 1230 is set to 0.5 mm, the antenna structure has a high antenna gain value of 9 dB or more in a whole frequency band.

Referring to FIG. 10B and (a) of FIG. 14B, when the width W3 of the third cavity 1230 is set to 1.5 mm, the first peak region PR1 and the second peak region PR2 of the electric field distribution of the antenna structure are defined in a first direction and a second direction, which are different directions. When the width W3 of the third cavity 1230 is 1.5 mm, an electric field generated by the first cavity 1210 and the second cavity 1220 is not synthesized in phase with an electric field generated by a dipole antenna, thus deteriorating radiation gain performance.

(a) of FIG. 14C shows a 3D radiation pattern of the antenna structure when the width W3 of the third cavity 1230 is 1.5 mm. Referring to FIG. 10B, (a) of FIG. 14B, and (a) of FIG. 14C, when the width W3 of the third cavity 1230 is 0.54 mm, radiation pattern components by the first cavity 1210 and the second cavity 1220 and a radiation pattern component by the dipole antenna are not synthesized but separated. Therefore, when the width W3 of the second cavity 1230 is 1.5 mm, phases of electric field components or phases of radiation pattern components of the cavity and the dipole antenna are not synthesized in phase. Accordingly, when the width W3 of the third cavity 1230 is 1.5 mm, deterioration in antenna performance occurs.

Referring to FIG. 10B and (b) of FIG. 14B, when the width W3 of the third cavity 1230 is set to 0.5 mm, the peak region PR of the electric field distribution of the antenna structure is defined in a same direction. When the width W3 of the third cavity 1230 is set to 0.5 mm, the peak region PR of the electric field distribution of the antenna structure is defined in a direction perpendicular to the antenna structure. Therefore, when the width W3 of the third cavity 1230 is 0.5 mm, an electric field generated by the first cavity 1210 and the second cavity 1220 may be synthesized in phase with an electric field generated by the dipole antenna. The electric field generated by the first cavity 1210 and the second cavity 1220 is synthesized in phase with the electric field generated by the dipole antenna, thereby improving radiation gain performance.

(b) of FIG. 14C shows a 3D radiation pattern of the antenna structure when the width W3 of the third cavity 1230 is 0.5 mm. Referring to FIG. 10B, (a) of FIG. 14B, and (b) of FIG. 14C, when the width W3 of the third cavity 1230 is 0.5 mm, radiation pattern components by the first cavity 1210 and the second cavity 1220 and a radiation pattern component by the dipole antenna are synthesized in a vertical direction of the antenna structure. A peak value of a radiation pattern of (b) of FIG. 12C when the width W3 of the third cavity 1230 is 0.5 mm is greater than a peak value of a radiation pattern of (a) of FIG. 12C when the width W3 of the third cavity 1230 is 1.5 mm. Therefore, when the width W3 of the third cavity 1230 is 0.5 mm, phases of electric field components or phases of radiation pattern components of the cavity and the dipole antenna are vertically synthesized in phase, thereby improving directivity. Accordingly, when the width W3 of the third cavity 1230 is 0.5 mm, a peak value of a radiation pattern is increased, thereby improving antenna performance. In addition, when the width W3 of the third cavity 1230 is 0.5 mm, a radiation pattern is generated in a left-right symmetrical shape with respect to a vertical direction, thereby improving antenna performance.

Referring to FIGS. 9A to 14C, the first cavity 1210 and the second cavity 1220 may be each configured to have a size of 1.18×0.74 mm in horizontal and vertical directions. The first cavity 1210 and the second cavity 1220 may be each configured to have a length L of 1.18 mm. The width W1 of the first cavity 1210 and the width W2 of the second cavity 1220 may be each configured to be 0.74 mm. The first cavity 1210 and the second cavity 1220 may be each configured to have a depth of 0.35 mm. The third cavity 1230 may be configured to have a width W3 of 0.5 mm.

The ground 1110g may be placed on the second surface S2 of the dielectric substrate 1010. The ground 1110g may include the first open area OA1, the second open area OA2, and the third open area OA3. The first open area OA1 may be arranged to have the second open area OA2 and the third open area OA3 at one side and another side, respectively.

The radiators 1110 may be placed in the first open area OA1 in a central portion of the second surface S2 of the dielectric substrate 1010. A first end of each of the radiators 1110 may be connected to a part of the ground 1110g. The microstrip feeder 1110f may be placed on the first surface S1 of the dielectric substrate 1010. A part of the ground 1110g may be electrically coupled to the microstrip feeder 1110f. The microstrip feeder 1110f arranged on the first surface S1 of the dielectric substrate 1010 may be electrically coupled to the slot 1100s on the first surface S1 of the dielectric substrate 1010 to be coupled-fed to the radiators 1110. The conductive pattern 1120 may be arranged on the second surface S2 of the dielectric substrate 1010. The conductive pattern 1120 may be electrically coupled to a second end of each of the radiators 1110.

Meanwhile, in the cavity-backed microstrip dipole antenna structure according to the specification, the radiators 1110 may be configured as a plurality of radiator patterns. Referring to FIGS. 9A to 10B, the radiators 1110 may be configured as the first radiator 1111 and the second radiator 1112. The second radiator 1112 may be configured to have a structure separate from the first radiator 1111. One end of the second radiator 1112 may be arranged to be spaced apart from an end of the first radiator 1111. Another end of the second radiator 1112 may be placed in the second cavity 1221 in a central region. The another end of the second radiator 1112 may be configured to have a predetermined length CL in one axial direction. The second radiator 1112 may include a first sub-pattern 1112a and a second sub-pattern 1112b corresponding to a coupling pattern. The first sub-pattern 1112b may be configured to have a predetermined length CL in one axial direction.

The slot 1110s may be configured to include a first part 1111s and a second part 1112s. The first part 1111s of the slot may be arranged between the first radiator pattern 1111a and the second radiator pattern 1111b. The second part 1112s of the slot may be arranged on the ground 1110g connected to the radiators 1100. The first part 1111s of the slot and the second part 1112s of the slot may be arranged to be connected to each other. A gap SG2 in the second part 1112s of the slot may be configured to be wider than a gap SG1 of the first part 1111s of the slot.

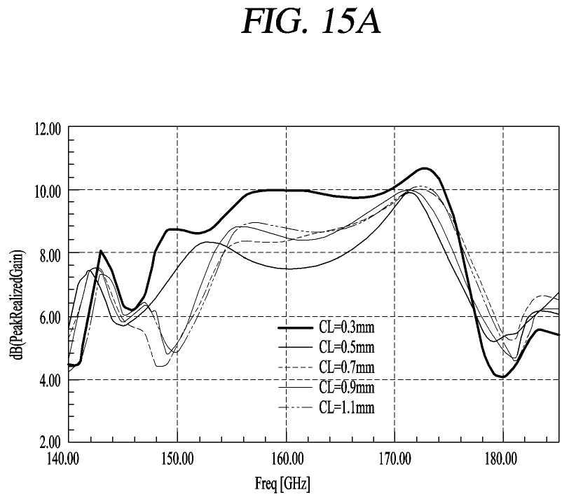

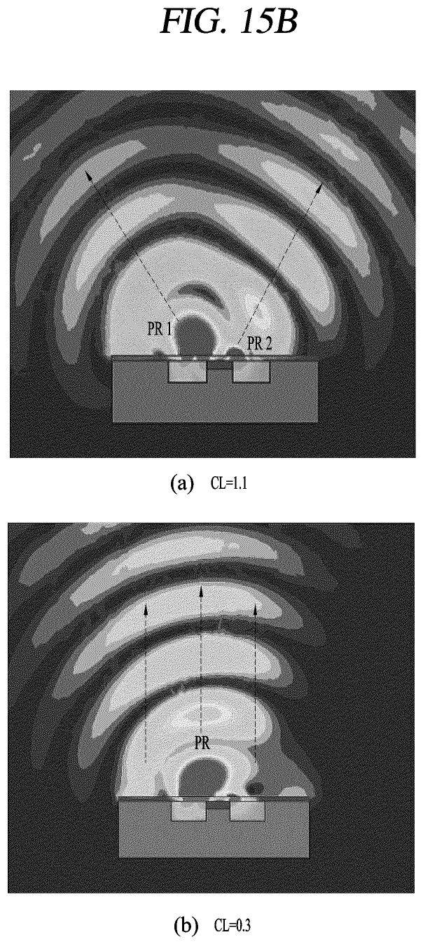

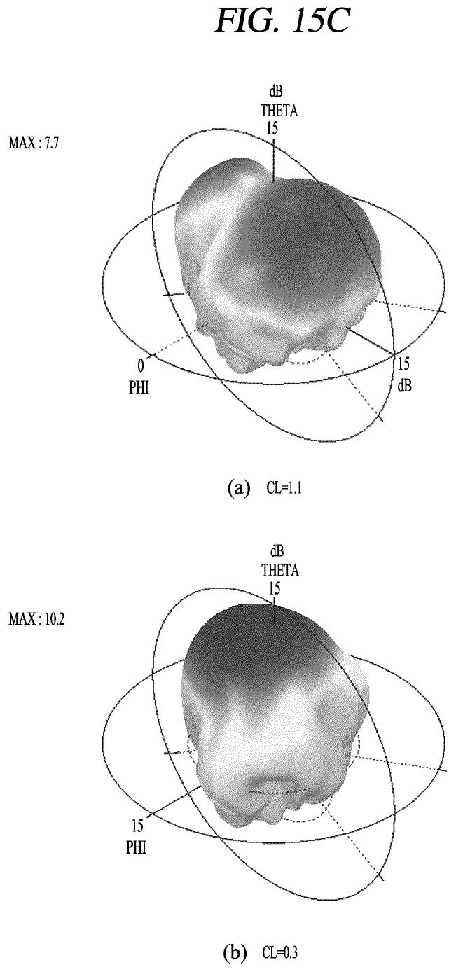

Antenna performance according to a change in the length CL of the second sub-pattern 1112b corresponding to a coupling pattern is described. In this regard, FIG. 15A shows antenna radiation gain characteristics according to a change in a length of a second sub-pattern. FIG. 15B shows electric field distributions of antenna structures including second sub-patterns having different lengths, respectively. FIG. 15C shows a 3D radiation pattern of the antenna structure having the second sub-patterns having different lengths and shown in FIG. 15B.

Referring to FIG. 10B and FIG. 15A, when the length CL of the second sub-pattern 1112b is set to 0.5 mm, 0.7 mm, and 0.9 mm, an antenna gain value is reduced to 8 dB or less in a frequency band of 155 GHz or less. When the length CL of the second sub-pattern 1112b is set to 1.1 mm, an antenna gain value is reduced to 8 dB or less in some frequency bands with reference to 160 GHz. When the length CL of the second sub-pattern 1112b is set to 0.3 mm, the antenna structure has a high antenna gain value of about 9 dB or more in a whole frequency band. When the length CL of the second sub-pattern 1112b is set to 0.3 mm, the antenna structure has a high antenna gain value of about 10 dB or more in a frequency band of 160 GHz or more.

Therefore, as the length CL of the second sub-pattern 1112b is changed, antenna radiation performance is changed. To perform in-phase feeding to the second cavity 121 in the central region, a design of the second sub-pattern 1112b corresponding to the coupling pattern needs to be optimized. A signal applied to the second cavity 121 and a cavity resonance mode is changed depending on the length CL of the second sub-pattern 1112b. Accordingly, when a signal applied to the second cavity 121 and a signal applied to the first cavity 111 are not synthesized in phase, antenna gain performance may deteriorate.

Referring to FIG. 10B and (a) of FIG. 15, when the length CL of the second sub-pattern 1112b is set to 1.1 mm, the first peak region PR1 and the second peak region PR2 of electric field distribution of the antenna structure are defined in a first direction and a second direction, which are different directions. When the length CL of the second sub-pattern 1112b is 1.1 mm, electric fields generated by the first cavity 1210 and the second cavity 1220 are not synthesized in phase with an electric field generated by a dipole antenna, thus worsening radiation gain performance.

(a) of FIG. 15C shows a 3D radiation pattern of the antenna structure when the length CL of the second sub-pattern 1112b is 1.1 mm. Referring to FIG. 10B, (a) of FIG. 15B, and (a) of FIG. 15C, when the length CL of the second sub-pattern 1112b is 1.1 mm, radiation pattern components by the first cavity 1210 and the second cavity 1220 and a radiation pattern component by the dipole antenna are not synthesized but separated. Accordingly, when the length CL of the second sub-pattern 1112b is 1.1 mm, phases of electric field components of the cavity and the dipole antenna or a phase of a radiation pattern component are not synthesized in phase. Accordingly, when the length CL of the second sub-pattern 1112b is 1.1 mm, antenna performance deterioration occurs.

Referring to FIG. 10B and (b) of FIG. 15B, when the length CL of the second sub-pattern 1112b is set to 0.3 mm, the peak region PR of an electric field distribution of the antenna structure is defined in a same direction. When the length CL of the second cavity 1112b is set to 0.3 mm, the peak region PR of the electric field distribution of the antenna structure is defined in a direction perpendicular to the antenna structure. Accordingly, when the length CL of the second cavity 1112b is 0.3 mm, electric fields generated by the first cavity 1210 and the second cavity 1220 may be synthesized in phase with an electric field generated by the dipole antenna. The electric fields generated by the first cavity 1210 and the second cavity 1220 are synthesized in phase with the electric field generated by the dipole antenna, thereby improving radiation gain performance.

(b) of FIG. 15C shows a 3D radiation pattern of the antenna structure when the length CL of the second sub-pattern 1112b is 0.3 mm. Referring to FIG. 10B, (a) of FIG. 15B, and (b) of FIG. 15C, when the length CL of the second sub-pattern 1112b is 0.3 mm, radiation pattern components by the first cavity 1210 and the second cavity 1220 and a radiation pattern component by the dipole antenna are synthesized in a vertical direction to the antenna structure. A peak value of a radiation pattern of (b) of FIG. 14C when the length CL of the second sub-pattern 1112b is 0.3 mm is greater than a peak value of a radiation pattern of (a) of FIG. 14C when the length CL of the second sub-pattern 1112b is 1.1 mm. Therefore, when the length CL of the second sub-pattern 1112b is 0.3 mm, phases of electric field components of the cavity and the dipole antenna or a phase of a radiation pattern component are vertically synthesized in phase, thereby improving directivity. Accordingly, when the length CL of the second sub-pattern 1112b is 0.3 mm, a peak value of the radiation pattern is increased, thereby improving antenna performance. In addition, when the length CL of the second sub-pattern 1112b is 0.3 mm, the radiation pattern is generated in a left-right symmetrical shape with reference to a vertical direction, thereby improving antenna performance.

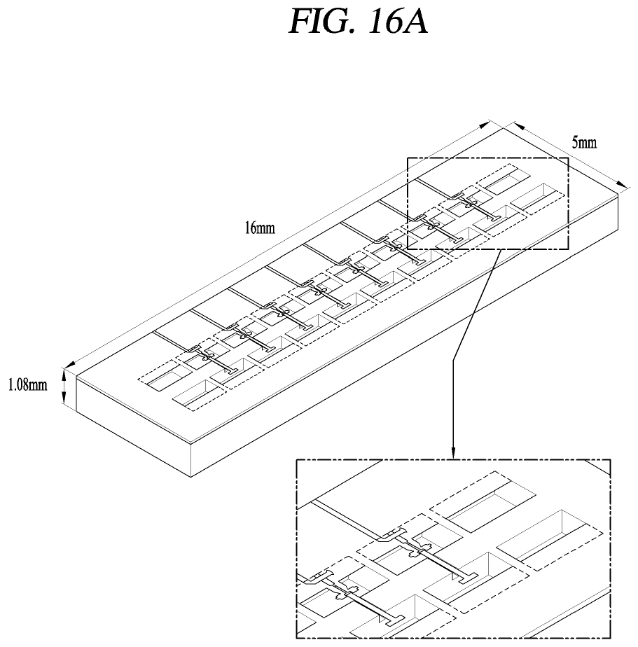

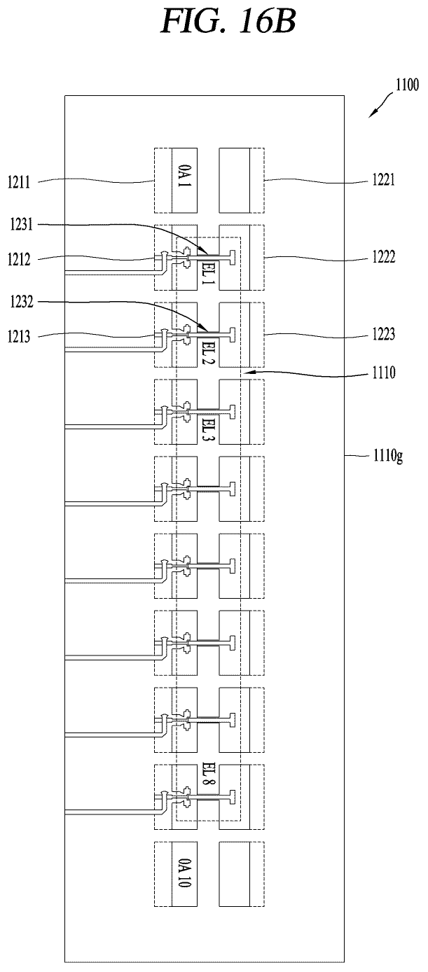

The cavity-backed microstrip dipole antenna structure has been described. Hereinafter, a cavity-backed microstrip dipole antenna array structure is to be described in detail. In this regard, FIGS. 16A and 16B illustrate a cavity-backed microstrip dipole antenna array structure. FIG. 16A is an enlarged perspective view of a partial region of the cavity-backed microstrip dipole antenna array structure. FIG. 16B is a front view of the cavity-backed microstrip dipole antenna array structure.

The antenna array structure of FIGS. 16A and 16B is illustrated as a 1×8 array antenna, but is not limited thereto and may be changed to a 1×4, 1×6, 1×10, 1×12, or 1×16 array antenna. Alternatively, the antenna array structure of FIGS. 16A and 16B may also be implemented as a two-dimensional array antenna such as an M×N array.

Referring to FIGS. 7A to 16B, a cavity-backed microstrip dipole antenna array 1100 may be configured to include the PCB 1100 and the metal substrate (metallic substrate) 1200. In this regard, the aforementioned description about the single antenna structure having a plurality of cavities may also be applied to the dipole antenna array structure of FIGS. 15A and 15B.

The metal substrate 1200 may be arranged in a region below the PCB 1100. The PCB 1100 and the metal substrate 1200 may be referred to as a first substrate and a second substrate, respectively.

The PCB 1100 may be configured to include the dielectric substrate 1010, the ground 1110g, and the radiators 1110. The PCB 1100 may be configured to further include the microstrip feeder 1110f and the conductive pattern 1120. The radiators 1110 may be also configured to include a first antenna element EL1 to an eighth antenna element EL8.

The dielectric substrate 1010 may include the first surface S1 and the second surface S2. The second surface S2 may be at an opposite side to the first surface S1. The first surface S1 and the second surface S2 may constitute a rear surface and a front surface of the dielectric substrate 1010, respectively. The ground 1110g may be placed on the second surface S2 of the dielectric substrate 1010. The ground 1110g may be configured to include a plurality of open areas. The ground 1110g may be configured to include the first open area OA1 to a tenth open area OA10 in one axial direction. Cavities may be arranged to correspond to the inclusion of the first open area OA1 to the tenth open area OA10.

An antenna element may not be placed in the first open area OA1, but arranged only in a cavity 1211. The first and second cavities 1211 and 1221 may be arranged in another axial direction. The first cavity 1211 may be configured to have a size, a shape, and a depth identical to those of the second cavity 1221.

A first antenna element EL1 may be placed in the second open area OA2, and a cavity 1212 may be arranged therebelow. The first cavity 1212 may be configured to have a size, a shape, and a depth identical to those of the second cavity 1222. A size and a depth of the third cavity 1232 may be configured to be smaller than a size and a depth of the second cavity 1222.

A second antenna element EL2 may be placed in the third open area OA3 and the cavity 1213 may be arranged therebelow. The first cavity 1213 may be configured to have a size, a shape, and a depth identical to those of the second cavity 1223. A size and a depth of the third cavity 1233 may be configured to be smaller than a size and a depth of the second cavity 1223. In a 1×8 array antenna structure, ten cavities may be arranged in one axial direction and three cavities may be arranged in another axial direction. In a 1×N array antenna structure, N+2 cavities may be arranged in one axial direction and three cavities may be arranged in another axial direction.

The cavity-backed microstrip dipole antenna structure according to one aspect of the specification has been described. Hereinafter, a microstrip dipole antenna structure having a cavity-backed and gap-coupling structure according to another aspect of the specification is described. In this regard, the aforementioned description about the cavity-backed microstrip dipole antenna structure may also be applied to a microstrip dipole antenna structure having a cavity-backed and gap-coupling structure described below.

Hereinafter, with reference to FIGS. 9A to 11 and 15, a microstrip dipole antenna structure of a cavity-backed and gap-coupling structure is described. The microstrip dipole antenna structure may be configured to include the PCB 1100 and the metal substrate 1200.

The PCB 1100 may be configured to include the dielectric substrate 1010, the ground 1110g, the first radiator 1111a, the second radiator 1111b, a first gap G1, and a second gap G2. The PCB 1100 may be configured to further include the microstrip feeder 1110f and the conductive pattern 1120.

The ground 1110g may be placed on the first surface S1 of the dielectric substrate 1010. The ground 1110g may include the first open area OA1, the second open area OA2, and the third open area OA3.

The first radiator 1111a may be placed in the first open area OA1 on the first surface S1 of the dielectric substrate 1010. A first end of each of the first radiator 1111a may be connected to the first part 1111g of the ground 1110g. The second radiator 1111b may be placed in the first open area OA1 of the first surface S1 of the dielectric substrate 1010. A second end of the second radiator 1111b may be connected to the second part 1112g of the ground 1110g.

The first gap G1 of the ground 1110g may be arranged between the first part 1111g of the ground 1110g and the second part 1112g of the ground 1110g. The second gap G2 may be arranged between the first radiator 1111a and the second radiator 1111b. The microstrip feeder 1110f may be placed on the second surface S2 of the dielectric substrate 1010. The microstrip feeder 1110f may be electrically coupled to the first part 1111g and the second part 1112g of the ground 1110g.

The conductive pattern 1120 may be arranged on the first surface S1 of the dielectric substrate 1010. The conductive pattern 1120 may be electrically coupled to a second end of the first radiator 1111a. The conductive pattern 1120 may be electrically coupled to a fourth end of the second radiator 1111b. The first and second radiators 1111a and 1111b and the conductive pattern 1120 are not directly connected to each other, but may be spaced apart by a predetermined gap so that signals from the first and second radiators 1111a and 1111b may be coupled to the conductive pattern 1120. Since the first and second radiators 1111a and 1111b and the conductive pattern 1120 are each connected to the ground 1110g, the first and second radiators 1111a and 1111b and the conductive pattern 1120 are not directly connected to each other, but connected through the ground 1110g.

The metal substrate 1200 may include the third surface S3, the fourth surface S4, the first cavity 1210, the second cavity 1220, and the third cavity 1230. The fourth surface S4 may be at an opposite side to the third surface S3. The fourth surface S4 of the metal substrate 1200 may be arranged to face the first surface S1 of the dielectric substrate 1010. The metal substrate 1200 may be configured to have a height of 1.0 mm. The dielectric substrate 1010 may be configured to have a height of 80 um.

The first cavity 1210 may be arranged on the fourth surface S4 of the metal substrate 1200. The first cavity 1210 may be arranged in a position overlapping the first and second radiators 1111a and 1111b and a first part of the conductive pattern 1200. The second cavity 1220 may be arranged on the fourth surface S4 of the metal substrate 1200. The second cavity 1220 may be arranged at a position overlapping a second part of the conductive pattern 1200. The third cavity 1230 may be arranged on the fourth surface S4 of the metal substrate 1200. The third cavity 1230 may be arranged to be connected to the first cavity 1210 and the second cavity 1220. The third cavity 1230 may be arranged at a position overlapping a middle part between the first part 1121 and the second part 1122 of the conductive pattern 1120. The first cavity 1210 may be configured to have a size, a shape, and a depth identical to those of the second cavity 1220. The third cavity 1230 may be configured to have a size and a depth smaller than a size and a depth of the first cavity 1210 or the second cavity 1220.

An inner side of the first cavity 1210, an inner side of the second cavity 1220, and an inner side of the third cavity 1230 may be composed of air.

The ground 1110g may constitute the open area OA1. The first and second radiators 1111a and 1l1b may be arranged in the open area OA1. The open area OA1 of the ground 1110g may be configured to have a size smaller than a size of the first cavity 1210.

The first part 1111s of the slot 1110s may be arranged between the first radiator 1111a and the second radiator 1111b. The second part 1112s of the slot 1110s may be arranged in the ground 1110g connected to the first radiator 1111a and the second radiator 1111b. The first part 1111s of the slot and the second part 1112s of the slot may be arranged to be connected to each other. The gap G1 in the second part 1112s of the slot may be configured to be wider than the gap G2 of the first part 1111s of the slot.

The first cavity 1210 and the second cavity 1220 may each have a size of 1.18×0.74 mm in horizontal and vertical directions. A depth of each of the first cavity 1210 and the second cavity 1220 may be 0.35 mm. A depth of the third cavity 1230 may be 0.13 mm.

The first cavity 1210 and the second cavity 1220 may be each arranged as three pieces at a central region and at one side region and another side region adjacent to the central region in a horizontal direction. The third cavity 1230 may be configured to connect the first cavity 1211 and the second cavity 1221 each in the central region in which the first radiator 1111a and the second radiator 1111b are placed. The third cavity 1230 may be configured to have a size of 0.12×0.5 mm in horizontal and vertical directions.

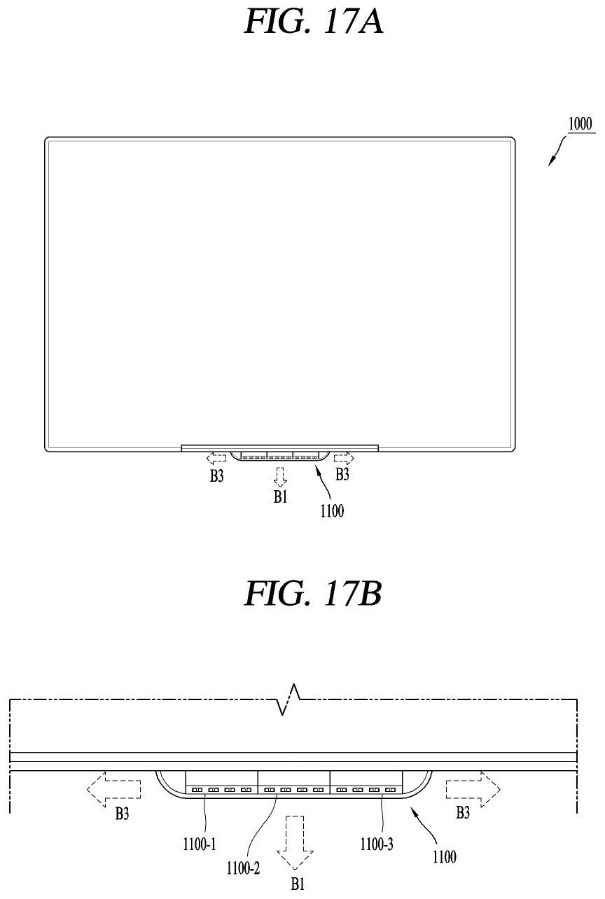

An antenna module to which the cavity-backed microstrip dipole antenna structure disclosed in this specification is applied may be configured as an array antenna in an electronic device. In this regard, FIG. 17A is a view of a structure in which an antenna module having a first type antenna and a second type antenna configured as array antennas is arranged in an electronic device. FIG. 17B is an enlarged view of a plurality of array antenna modules.

Referring to FIGS. 1 to 17B, the array antenna may include a first array antenna module 1100-1, and a second array antenna module 1100-2 spaced apart from the first array antenna module 1100-1 by a certain gap in a first horizontal direction. In some embodiments, the number of array antennas is not limited to two, but may be at least three as illustrated in FIG. 16B. Therefore, the array antenna may include a first array antenna module 1100-1 to a third array antenna module 1100-3.

The processor 1400 of FIGS. 5 to 6C may control the first array antenna module 1100-1 and the second array antenna module 1100-2 to generate a first beam and a second beam in a first direction and a second direction, respectively. For example, the processor 1400 may control the first array antenna module 1100-1 to generate the first beam horizontally in the first direction. Also, the processor 1400 may control the second array antenna module 1100-2 to generate the second beam horizontally in the second direction. In this regard, the processor 1400 may perform MIMO using the first beam of the first direction and the second beam of the second direction.

The processor 1400 may generate a third beam in a third direction using the first and second array antenna modules 1100-1 and 1100-2. In this regard, the processor 1400 may control the transceiver circuit 1250 to synthesize signals received through the first and second array antenna modules 1100-1 and 1100-2. Also, the processor 1400 may control the transceiver circuit 1250 to distribute signals transmitted to the first and second array antenna modules 1100-1 and 1100-2 into each antenna element. The processor 1400 may perform beamforming using the third beam which has a beam width narrower than those of the first beam and the second beam.

In some embodiments, the processor 1400 may perform MIMO using the first beam of the first direction and the second beam of the second direction, and perform beamforming using the third beam having the narrower beam width than those of the first beam and the second beam. In relation to this, when a first signal and a second signal received from other electronic devices in the vicinity of the electronic device have qualities lower than or equal to a threshold value, the processor 1400 may perform beamforming using the third beam.

The number of elements of the array antenna may be two, three, four, and the like as illustrated, but is not limited thereto. For example, the number of elements of the array antenna may be expanded to two, four, eight, sixteen, and the like. Therefore, the array antenna may be configured as 1×2, 1×3, 1×4, 1×5, . . . , 1×8 array antenna.

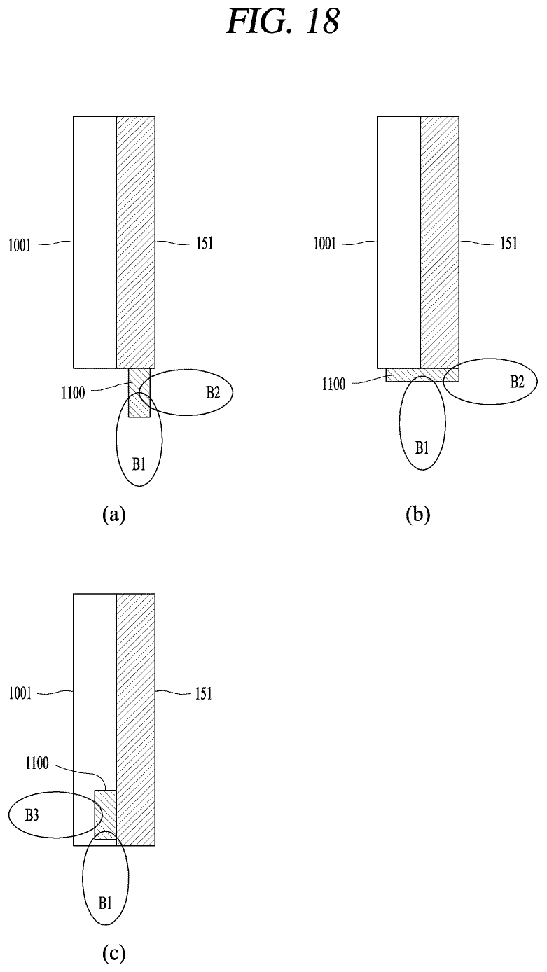

Meanwhile, FIG. 18 is a view of an antenna module coupled in a different coupling structure at a specific position of an electronic device according to embodiments. Referring to (a) of FIG. 18, the antenna module 1100 may be arranged in the lower region of the display 151 to be substantially horizontal to the display 151. Accordingly, a beam B1 may be generated in the lower direction of the electronic device through any one array antenna of the plurality of array antenna modules. In some embodiments, another beam B2 may be generated in a front direction of the electronic device through another array antenna of the plurality of array antenna modules.

Referring to (b) of FIG. 18, the array antenna module 1100 may be arranged in the lower region of the display 151 to be substantially perpendicular to the display 151. Accordingly, a beam B2 may be generated in the front direction of the electronic device through any one array antenna of the plurality of array antenna modules. In some embodiments, another beam B1 may be generated in the lower direction of the electronic device through another array antenna of the plurality of array antenna modules.

Referring to (c) of FIG. 18, the antenna module 1100 may be arranged, for example, inside a rear case 1001 corresponding to a mechanism structure. The antenna module 1100 may be arranged inside the rear case 1001 to be substantially parallel to the display 151. Accordingly, a beam B2 may be generated in the lower direction of the electronic device through any one array antenna of the plurality of array antenna modules. In some embodiments, another beam B3 may be generated in a rear direction of the electronic device through another array antenna of the plurality of array antenna modules.

A cavity-backed microstrip dipole antenna and an electronic device including the same have been described. Hereinafter, technical effects of the cavity-backed microstrip dipole antenna and an electronic device including the same will be described.

According to an embodiment, an antenna module operating in a terahertz band and an electronic device including the same may be provided.

According to an embodiment, an antenna structure for a terahertz band having a high radiation gain and wide bandwidth performance through a multi-cavity structure may be designed.

According to an embodiment, high radiation gain performance may be secured in a whole 6G frequency band through optimal design of a shape, a size, and a depth of a multi-cavity structure.

According to an embodiment, electric field distributions between antenna structures may be synthesized in phase through optimal design of a shape, a size, and a depth of a multi-cavity structure, thereby improving antenna directivity and a radiation gain.

Further scope of applicability of the disclosure will become apparent from the following detailed description. It should be understood, however, that the detailed description and specific examples, such as the preferred embodiments, are given by way of illustration only, because various changes and modifications within the technical idea and scope of the disclosure will be apparent to those skilled in the art.

The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller of the terminal. Therefore, the detailed description should not be limitedly construed in all of the aspects, and should be understood to be illustrative. Therefore, all changes and modifications that fall within the metes and bounds of the claims, or equivalents of such metes and bounds are therefore intended to be embraced by the appended claims.

What is claimed is:

1. A dipole antenna array, in a cavity-backed microstrip dipole antenna array, comprising:
a printed circuit board (PCB) comprising:
a dielectric substrate;
a ground arranged on a second surface of the dielectric substrate, the ground comprising a first open area, a second open area, and a third open area;
radiators arranged in the first open area on the second surface of the dielectric substrate, a first end of each of the radiators being connected to a part of the ground; and
a microstrip feeder arranged on a first surface of the dielectric substrate, a part of the ground being electrically coupled to the microstrip feeder; and
a conductive pattern arranged on the second surface of the dielectric substrate, the conductive pattern being electrically coupled to a second end of each of the radiators; and
a metal substrate,
wherein the metal substrate comprises:
a third surface;
a fourth surface being at an opposite side to the third surface, wherein the fourth surface of the metal substrate is faced with the first surface of the dielectric substrate;
a first cavity arranged on the fourth surface of the metal substrate, the first cavity being arranged at a position overlapping the radiators and a first part of the conductive pattern;
a second cavity arranged on the fourth surface of the metal substrate, the second cavity being arranged at a position overlapping a second part of the conductive pattern; and
a third cavity arranged on the fourth surface of the metal substrate, the third cavity being connected to the first cavity and the second cavity, and the third cavity being arranged at a position overlapping a middle part between the first part and the second part of the conductive pattern, and
wherein a size, a shape, and a depth of the first cavity are identical to a size, a shape, and a depth of the second cavity, and
a size and a depth of the third cavity are smaller than the size and the depth of the second cavity.

2. The dipole antenna array of claim 1, wherein an inner side of the first cavity, an inner side of the second cavity, and an inner side of the third cavity are composed of air.

3. The dipole antenna array of claim 1, wherein the ground constitutes an open area, and
radiators are arranged in the open area.

4. The dipole antenna array of claim 3, wherein the open area of the ground has a size smaller than the size of the first cavity.

5. The dipole antenna array of claim 1, wherein the radiators are configured as a first radiator pattern and a second radiator pattern,
a first part of a slot is arranged between the first radiator pattern and the second radiator pattern,
a second part of the slot is arranged on the ground connected to the radiators,
the first part of the slot and the second part of the slot are connected to each other, and
a gap in the second part of the slot is configured to be wider than the first part of the slot.

6. The dipole antenna array of claim 1, wherein the sizes of the first cavity and the second cavity are each 1.18×0.74 mm in horizontal and vertical directions, and the depths of the first cavity and the second cavity are each 0.35 mm.

7. The dipole antenna array of claim 6, wherein the depth of the third cavity is 0.13 mm.

8. The dipole antenna array of claim 7, wherein the first cavity and the second cavity are each arranged as three pieces at a central region and at one side region and another side region adjacent to the central region in a horizontal direction,
the third cavity is configured to connect the first cavity and the second cavity each in the central region in which the radiator is arranged, and
the size of the third cavity is 0.12×0.5 mm in horizontal and vertical directions.

9. The dipole antenna array of claim 1, wherein a height of the metal substrate is 1.0 mm.

10. The dipole antenna array of claim 9, wherein a height of the dielectric substrate is 80 um.

11. A dipole antenna array, in a cavity-backed microstrip dipole antenna array, comprising:
a printed circuit board (PCB) comprising:
a dielectric substrate;
a ground arranged on a first surface of the dielectric substrate, the ground comprising a first open area, a second open area, and a third open area;
a first radiator arranged in the first open area on the first surface of the dielectric substrate, a first end of the first radiator being connected to a first part of the ground;
a second radiator arranged in the first open area on the first surface of the dielectric substrate, a third end of the second radiator being connected to a second part of the ground;
a first gap arranged between the first part of the ground and the second part of the ground;
a second gap arranged between the first radiator and the second radiator;
a microstrip feeder arranged on a second surface of the dielectric substrate, the microstrip feeder being electrically coupled to the first part and the second part of the ground; and
a conductive pattern arranged on the first surface of the dielectric substrate, the conductive pattern being electrically coupled to a second end of the first radiator and a fourth end of the second radiator; and
a metal substrate,
wherein the metal substrate comprises:
a third surface;
a fourth surface being at an opposite side to the third surface, wherein the fourth surface of the metal substrate is faced with the first surface of the dielectric substrate;
a first cavity arranged on the fourth surface of the metal substrate, the first cavity being arranged at a position overlapping the first radiator and the second radiator and a first part of the conductive pattern;
a second cavity arranged on the fourth surface of the metal substrate, the second cavity being arranged at a position overlapping a second part of the conductive pattern; and
a third cavity arranged on the fourth surface of the metal substrate, the third cavity being connected to the first cavity and the second cavity, and the third cavity being arranged at a position overlapping a middle part between the first part and the second part of the conductive pattern, and
wherein a size, a shape and a depth of the first cavity are identical to a size, a shape and a depth of the second cavity, and
a size and a depth of the third cavity are smaller than the size and the depth of the second cavity.

12. The dipole antenna array of claim 11, wherein an inner side of the first cavity, an inner side of the second cavity, and an inner side of the third cavity are composed of air.

13. The dipole antenna array of claim 11, wherein the ground constitutes an open area, and
the first and second radiators are arranged in the open area.

14. The dipole antenna array of claim 13, wherein the open area of the ground has a size smaller than the size of the first cavity.

15. The dipole antenna array of claim 11, wherein a first part of a slot is arranged between the first radiator and the second radiator,
a second part of the slot is arranged on the ground connected to the radiators,
the first part of the slot and the second part of the slot are connected to each other, and
a gap in the second part of the slot is configured to be wider the first part of the slot.

16. The dipole antenna array of claim 11, wherein the sizes of the first cavity and the second cavity are each 1.18×0.74 mm in horizontal and vertical directions, and the depths of the first cavity and the second cavity are each 0.35 mm.

17. The dipole antenna array of claim 16, wherein the depth of the third cavity is 0.13 mm.

18. The dipole antenna array of claim 17, wherein the first cavity and the second cavity are each arranged as three pieces at a central region and at one side region and another side region adjacent to the central region in a horizontal direction,
the third cavity is configured to connect the first cavity and the second cavity each in the central region in which the radiators are arranged, and
the size of the third cavity is 0.12×0.5 mm in horizontal and vertical directions.

19. The dipole antenna array of claim 11, wherein a height of the metal substrate is 1.0 mm.

20. The dipole antenna array of claim 19, wherein a height of the dielectric substrate is 80 um.
